(19) United States
(12) Patent Application Publication
(10) Pub. No.: US 2025/0220336 A1
(43) Pub. Date: Jul. 3, 2025

(54) APPARATUS

(71) Applicant: LG DISPLAY CO., LTD., Seoul (KR)

(72) Inventors: JeongMan LEE, Paju-si (KR); JaeHong KIM, Paju-si (KR)

(73) Assignee: LG DISPLAY CO., LTD., Seoul (KR)

(21) Appl. No.: 18/799,899

(22) Filed: Aug. 9, 2024

(30) Foreign Application Priority Data
Dec. 27, 2023 (KR) 10-2023-0192959

(51) Int. Cl. H04R 1/28; H04R 1/40; H04R 7/04; H04R 17/10

(52) U.S. Cl. CPC H04R 1/2811; H04R 1/403; H04R 7/045; H04R 17/10; H04R 2499/15

(57) ABSTRACT

An apparatus includes a vibration member, a vibration apparatus configured to vibrate the vibration member, a supporting member at a rear surface of the vibration apparatus and the vibration member, the supporting member including a hole region overlapping the vibration apparatus, an enclosure configured between the vibration member and the supporting member to surround the vibration apparatus, and a pad member between the vibration apparatus and the hole region of the supporting member. The pad member may be connected to one or more of the rear surface of the vibration apparatus and the supporting member.

### CROSS-REFERENCE TO RELATED APPLICATION

This application claims the priority of Korea Patent Application No. 10-2023-0192959 filed on Dec. 27, 2023, which is hereby incorporated by reference in its entirety.

### BACKGROUND

### Field of the Disclosure

The present disclosure relates to an apparatus, and more particularly, to an apparatus which can output a sound.

### Description of the Background

Apparatuses include a separate speaker or a sound apparatus for providing a sound. When a speaker is disposed in a display apparatus, the speaker occupies a space; due to this, the design and spatial disposition of the display apparatus are limited.

A speaker applied to the apparatus may be, for example, an actuator, including a magnet and a coil. However, when the actuator is applied to the apparatus, a thickness thereof is large. Piezoelectric elements that enable thinness to be implemented are attracting much attention.

### SUMMARY

In piezoelectric device used for piezoelectric speakers, a lowest resonance frequency increases due to high stiffness, and due to this, a sound pressure level of a low-pitched sound band is inevitably insufficient. Therefore, the piezoelectric speakers have a technical problem where a sound pressure level of the low-pitched sound band is not sufficient, and due to this, apparatuses including a piezoelectric speaker have a technical problem where a sound pressure level characteristic of the low-pitched sound band is not sufficient.

Accordingly, the present disclosure is directed to an apparatus that substantially obviates one or more of the problems due to limitations and disadvantages described above.

More specifically, the present disclosure is to provide an apparatus for enhancing a sound characteristic and/or a sound pressure level characteristic of a low-pitched sound band of the apparatus.

The present disclosure is also to provide an apparatus which may enhance a sound characteristic and/or a sound pressure level characteristic of a low-pitched sound band.

Further, the present disclosure is to provide an apparatus which may enhance a sound characteristic and/or a sound pressure level characteristic of a low-pitched sound band and may output a sound in both directions.

Additional features and aspects will be set forth in the description that follows, and in part will be apparent from the description, or may be learned by practice of the inventive concepts provided herein. Other features and aspects of the inventive concepts may be realized and attained by the structure particularly pointed out in the written description, or derivable therefrom, and the claims hereof as well as the appended drawings.

To achieve these and other advantages and aspects of the present disclosure, as embodied and broadly described herein, an apparatus includes a vibration member; a vibration apparatus configured to vibrate the vibration member; a supporting member at a rear surface of the vibration apparatus and the vibration member, the supporting member including a hole region overlapping the vibration apparatus; an enclosure configured between the vibration member and the supporting member to surround the vibration apparatus; and a pad member between the vibration apparatus and the hole region of the supporting member. The pad member may be connected to one or more of the rear surface of the vibration apparatus and the supporting member.

In another aspect of the present disclosure, an apparatus includes a vibration member, a supporting member at a rear surface of the vibration member, the supporting member including a hole region, an enclosure configured to provide a gap space between the vibration member and the hole region of the supporting member, a vibration apparatus configured in the gap space and configured to vibrate the vibration member, and a pad member at the gap space.

In a further aspect of the present disclosure, an apparatus may comprise a vibration member configured to generate a vibration or sound, a vibration apparatus configured to vibrate or sound the vibration member based on a displacement of the vibration member, a supporting member accommodating the vibration member and the vibration apparatus, a low-pitched sound band expander surrounding the vibration apparatus and optimizing a vibration region of the vibration member to increase a low-pitched sound band of the vibration apparatus, and a high-pitched sound band adjustor connecting the vibration apparatus and the supporting member and preventing the vibration of a center portion of the vibration apparatus to decrease a high-pitched sound band of the vibration apparatus.

In an apparatus according to one or more aspects of the present disclosure, a sound characteristic and/or a sound pressure level characteristic may be enhanced.

In an apparatus according to one or more aspects of the present disclosure, a sound characteristic and/or a sound pressure level characteristic may be enhanced and a sound may be output in both directions.

Other systems, methods, features and advantages will be, or will become, apparent to one with skill in the art upon examination of the following figures and detailed description. It is intended that all such additional systems, methods, features and advantages be included within this description, be within the scope of the present disclosure, and be protected by the following claims. Nothing in this section should be taken as a limitation on those claims. Further aspects and advantages are discussed below in conjunction with aspects of the disclosure.

It is to be understood that both the foregoing description and the following description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure, and incorporated in and constitute a part of this disclosure, illustrate aspects of the disclosure and together with the description serve to explain principles of the disclosure.

In the drawings:

FIG. 1 is a perspective view illustrating an apparatus according to an aspect of the present disclosure;

FIG. 2 is an exploded perspective view illustrating an apparatus according to an aspect of the present disclosure;

FIG. 3 is a cross-sectional view taken along line I-I′ illustrated in FIG. 1;

FIG. 4 illustrates a rear surface of a vibration member, a vibration apparatus, a hole region, an enclosure, and a pad member illustrated in FIGS. 2 and 3;

FIG. 5 is an enlarged view of a portion ‘A’ illustrated in FIG. 3;

FIG. 6 illustrates an enclosure according to another aspect of the present disclosure;

FIG. 7 illustrates an enclosure according to another aspect of the present disclosure;

FIG. 8A illustrates an exciting force of a vibration apparatus according to an aspect of the present disclosure;

FIG. 8B illustrates a first-order mode shape of the vibration apparatus according to an aspect of the present disclosure;

FIG. 8C illustrates a second-order mode shape of the vibration apparatus according to an aspect of the present disclosure;

FIG. 8D illustrates an n-order mode shape of the vibration apparatus according to an aspect of the present disclosure;

FIG. 9 illustrates an arrangement structure of a pad member according to an aspect of the present disclosure;

FIG. 10 illustrates an arrangement structure of a pad member according to another aspect of the present disclosure;

FIG. 11 illustrates an arrangement structure of a pad member according to another aspect of the present disclosure;

FIG. 12 illustrates an arrangement structure of a pad member according to another aspect of the present disclosure;

FIG. 13 illustrates a vibration apparatus according to an aspect of the present disclosure;

FIG. 14 is a cross-sectional view taken along line I-I′ illustrated in FIG. 13;

FIG. 15 is a cross-sectional view taken along line II-II′ illustrated in FIG. 13;

FIG. 16 illustrates a vibration layer according to another aspect of the present disclosure;

FIG. 17 illustrates a vibration layer according to another aspect of the present disclosure;

FIG. 18 is an exploded perspective view illustrating a vibration apparatus according to another aspect of the present disclosure;

FIG. 19 is a graph showing a sound pressure level with a frequency in each of an apparatus according to a first experiment example and an apparatus according to an aspect of the present disclosure;

FIG. 20 is a graph showing a sound pressure level with respect to a frequency in each of apparatuses according to first to third experiment examples and an apparatus according to an aspect of the present disclosure; and

FIG. 21 is a graph showing a sound pressure level with respect to a frequency in each of the apparatus according to the second experiment example and an apparatus according to another aspect of the present disclosure.

Throughout the drawings and the detailed description, unless otherwise described, the same drawing reference numerals should be understood to refer to the same elements, features, and structures. The sizes, lengths, and thicknesses of layers, regions and elements, and depiction of thereof may be exaggerated for clarity, illustration, and/or convenience.

### DETAILED DESCRIPTION

Reference is now made in detail to aspects of the present disclosure, examples of which may be illustrated in the accompanying drawings. In the following description, when a detailed description of well-known methods, functions, structures or configurations may unnecessarily obscure aspects of the present disclosure, a detailed description of such known functions or configurations may have been omitted for brevity. Further, repetitive descriptions may be omitted for brevity. The progression of processing steps and/or operations described is a non-limiting example.

The sequence of steps and/or operations is not limited to that set forth herein and may be changed to occur in an order that is different from an order described herein, with the exception of steps and/or operations necessarily occurring in a particular order. In one or more examples, two operations in succession may be performed substantially concurrently, or the two operations may be performed in a reverse order or in a different order depending on a function or operation involved.

Unless stated otherwise, like reference numerals may refer to like elements throughout even when they are shown in different drawings. Unless stated otherwise, the same reference numerals may be used to refer to the same or substantially the same elements throughout the specification and the drawings. In one or more aspects, identical elements (or elements with identical names) in different drawings may have the same or substantially the same functions and properties unless stated otherwise. Names of the respective elements used in the following explanations are selected only for convenience and may be thus different from those used in actual products.

Advantages and features of the present disclosure, and implementation methods thereof, are clarified through the aspects described with reference to the accompanying drawings. The present disclosure may, however, be embodied in different forms and should not be construed as limited to the example aspects set forth herein. Rather, these example aspects are examples and are provided so that this disclosure may be thorough and complete to assist those skilled in the art to understand the inventive concepts without limiting the protected scope of the present disclosure.

Shapes, dimensions (e.g., sizes, lengths, widths, heights, thicknesses, locations, radii, diameters, and areas), proportions, ratios, angles, numbers, the number of elements, and the like disclosed herein, including those illustrated in the drawings, are merely examples, and thus, the present disclosure is not limited to the illustrated details. Any implementation described herein as an “example” is not necessarily to be construed as preferred or advantageous over other implementations. It is, however, noted that the relative dimensions of the components illustrated in the drawings are part of the present disclosure.

Where a term like “comprise,” “have,” “include,” “contain,” “constitute,” “made of,” “formed of,” “composed of,” or the like is used with respect to one or more elements (e. g., layers, films, regions, components, sections, members, parts, areas, portions, steps, operations, and/or the like), one or more other elements may be added unless a term such as “only” or the like is used. The terms used in the present disclosure are merely used to describe example aspects, and are not intended to limit the scope of the present disclosure. The terms of a singular form may include plural forms unless the context clearly indicates otherwise.

In one or more aspects, unless explicitly stated otherwise, element, feature, or corresponding information (e.g., a level, range, dimension, size, or the like) is construed to include an error or tolerance range even where no explicit description of such an error or tolerance range is provided. An error or tolerance range may be caused by various factors (e.g., process factors, internal or external impact, noise, or the like). In interpreting a numerical value, the value is interpreted as including an error range unless explicitly stated otherwise.

Spatially relative terms, such as “below,” “beneath,” “lower,” “on,” “above,” “upper” and the like, may be used to describe a correlation between various elements (e. g., layers, films, regions, components, sections, or the like) as shown in the drawings. The spatially relative terms are to be understood as terms including different orientations of the elements in use or in operation in addition to the orientation depicted in the drawings. For example, if the elements shown in the drawings are turned over, elements described as “below” or “beneath” other elements would be oriented “above” other elements. Thus, the term “below,” which is an example term, may include all directions of “above” and “below.” Likewise, an exemplary term “above” or “on” may include both directions of “above” and “below.”

In describing a temporal relationship, when the temporal order is described as, for example, “after,” “subsequent,” “next,” “before,” “preceding,” “prior to,” or the like, a case that is not consecutive or not sequential may be included and thus one or more other events may occur therebetween, unless a more limiting term, such as “just,” “immediate(ly),” or “direct(ly),” is used.

It is understood that, although the terms “first,” “second,” or the like may be used herein to describe various elements (e.g., layers, films, regions, components, sections, members, parts, areas, portions, steps, operations, and/or the like), these elements should not be limited by these terms, for example, to any particular order, precedence, or number of elements. These terms are used only to distinguish one element from another. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” or the like may be used. These terms are intended to identify the corresponding element(s) from the other element(s), and these are not used to define the essence, basis, order, or number of the elements.

For the expression that an element (e. g., layer, film, region, component, section, or the like) is described as “connected,” “coupled,” “attached,” “adhered,” or the like to another element, the element may not only be directly connected, coupled, attached, adhered, or the like to another element, but also be indirectly connected, coupled, attached, adhered, or the like to another element with one or more intervening elements disposed or interposed between the elements, unless otherwise specified.

The term “at least one” should be understood as including any and all combinations of one or more of the associated listed items. For example, each of the phrases of “at least one of a first item, a second item, or a third item” and “at least one of a first item, a second item, and a third item”, may represent (i) a combination of items provided by one or more of the first item, the second item, and the third item or (ii) only one of the first item, the second item, and the third item.

Features of various aspects of the present disclosure may be partially or entirely coupled to or combined with each other, may be technically associated with each other, and may be operated, linked, or driven together in various ways. Aspects of the present disclosure may be implemented or carried out independently from each other, or may be implemented or carried out together in a co-dependent or related relationship. In one or more aspects, the components of each apparatus according to various aspects of the present disclosure may be operatively coupled and configured.

“X-axis direction,” “Y-axis direction,” and “Z-axis direction,” should not be construed by a geometric relation only of a mutual vertical relation and may have broader directionality within the range that elements of the present disclosure may act functionally.

In addition, for convenience of description, a scale, dimension, size, and thickness of each of the elements illustrated in the accompanying drawings may be different from an actual scale, dimension, size, and thickness, and thus, aspects of the present disclosure are not limited to a scale, dimension, size, and thickness illustrated in the drawings.

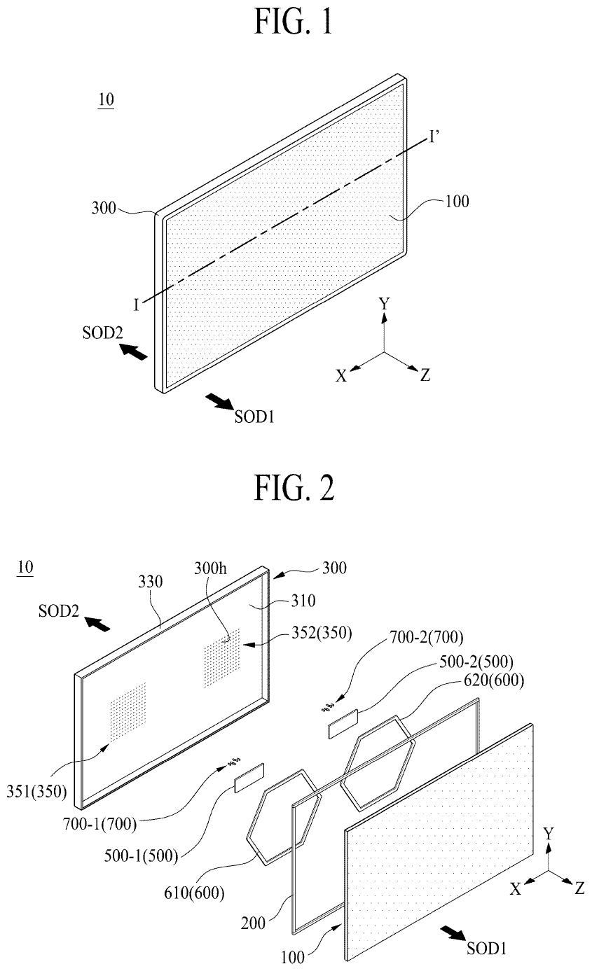

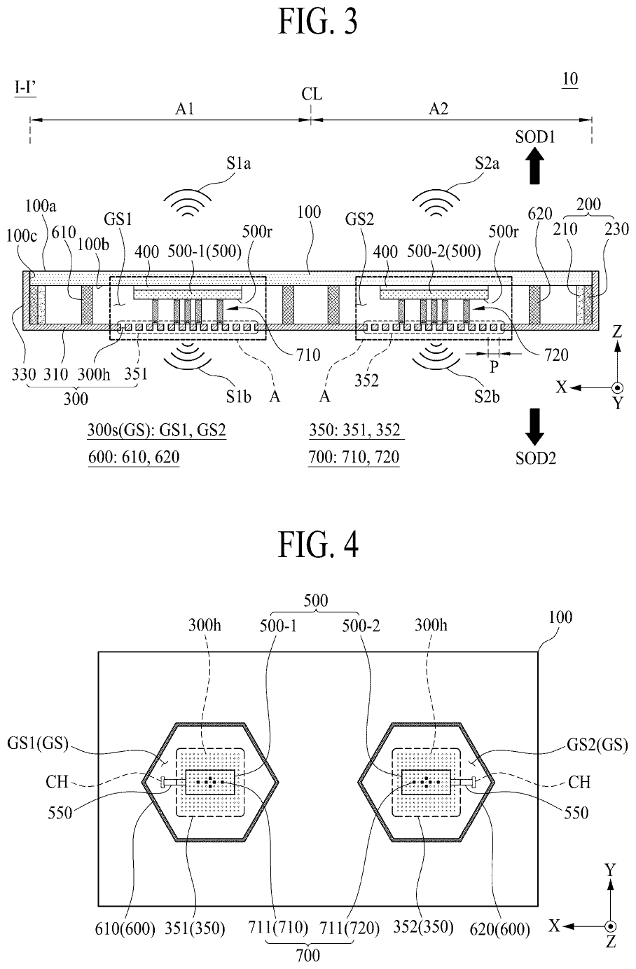

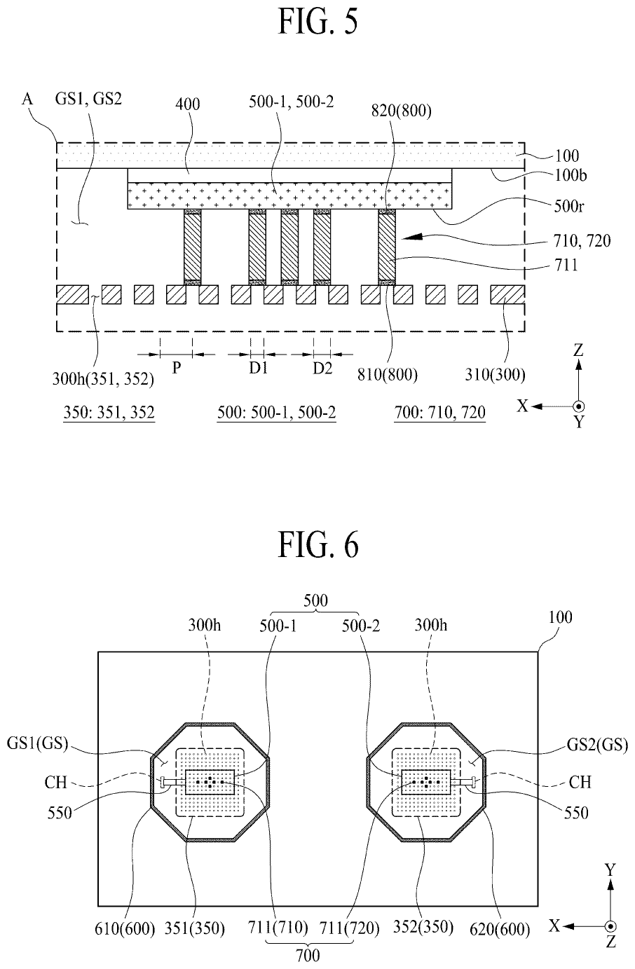

FIG. 1 is a perspective view illustrating an apparatus according to an aspect of the present disclosure. FIG. 2 is an exploded perspective view illustrating an apparatus according to an aspect of the present disclosure. FIG. 3 is a cross-sectional view taken along line I-I′ illustrated in FIG. 1. FIG. 4 illustrates a rear surface of a vibration member, a vibration apparatus, a hole region, an enclosure, and a pad member illustrated in FIGS. 2 and 3. FIG. 5 is an enlarged view of a portion ‘A’ illustrated in FIG. 3.

With reference to FIGS. 1 to 3, an apparatus 10 according to an aspect (or a first aspect) of the present disclosure may implement or realize a sound apparatus, a sound output apparatus, a vibration apparatus, a vibration generating apparatus, a sound bar, a sound system, a sound apparatus for electronic apparatuses, a sound apparatus for displays, a sound apparatus for vehicular apparatuses, or a sound bar for vehicular apparatuses, or the like. For example, a vehicular apparatus may include one or more seats and one or more glass windows. For example, the vehicular apparatus may include a vehicle, a train, a ship, or an aircraft, but aspects of the present disclosure are not limited thereto. Further, the apparatus 10 may implement or realize an analog signage or a digital signage, or the like such as an advertising signboard, a poster, or a noticeboard, or the like.

The apparatus 10 according to an aspect of the present disclosure may be a display apparatus which includes a plurality of pixels, but aspects of the present disclosure are not limited thereto.

The display apparatus may include a display panel which includes a plurality of pixels for configuring a black/white or a color image, and a driver configured to drive the display panel. The pixel may be a subpixel which configures one of a plurality of colors implementing a color image.

The apparatus 10 according to an aspect of the present disclosure may include a set electronic apparatus or a set device (or a set apparatus) such as notebook computers, televisions (TVs), computer monitors, equipment apparatuses including an automotive apparatus or another type apparatus for vehicles, or mobile electronic apparatuses such as smartphones or electronic pads, which is a complete product (or a final product) including a display panel such as a liquid crystal display panel or an organic light emitting display panel, or the like.

The apparatus 10 according to an aspect of the present disclosure may include a vibration member 100, a supporting member 300, and a vibration apparatus 500.

The vibration member 100 may generate a vibration or may output a sound (or a sound wave), based on a displacement (or driving or vibration) of the vibration apparatus 500. The vibration member 100 may be a vibration object, a display member, a display panel, a signage panel, a passive vibration plate, a front member, a rear member, a vibration panel, a sound panel, a passive vibration panel, a sound output plate, a sound vibration plate, or an image screen, or the like, but aspects of the present disclosure are not limited thereto.

The vibration member 100 according to an aspect of the present disclosure may include a polygonal shape including a rectangular shape or a square shape, but aspects of the present disclosure are not limited thereto. The vibration member 100 may include a horizontal length (or a widthwise length) parallel to a first direction X and a vertical length (or a lengthwise length) parallel to a second direction (or a Y-axis direction) Y. For example, with respect to a same plane, the first direction X may be a first horizontal direction, an X-axis direction, or a first horizontal length direction (or a long-side length direction) of the vibration member 100. For example, the second direction Y may be a second horizontal direction, a Y-axis direction, or a second horizontal length direction (or a short-side length direction) of the vibration member 100 which are orthogonal to the first direction X.

The vibration member 100 according to an aspect of the present disclosure may include a structure having substantially the same thickness, but aspects of the present disclosure are not limited thereto. For example, the vibration member 100 may include a plate structure having substantially the same thickness, but aspects of the present disclosure are not limited thereto. For example, the vibration member 100 may include one or more of a planar structure and a nonplanar structure.

According to an aspect of the present disclosure, the vibration member 100 may include a first surface 100a, a second surface 100b, and a plurality of lateral surfaces 100c.

In the vibration member 100, the first surface 100a may be a front surface, a forward surface, a top surface, or an upper surface. The second surface 100b may be a rear surface, a rearward surface, a backside surface, a bottom surface, or a lower surface. Each of the plurality of lateral surfaces 100c may be a side, an outer side, a sidewall, or an outer wall.

According to an aspect of the present disclosure, each of the first surface 100a and the second surface 100b of the vibration member 100 may include a planar structure. The vibration member 100 may include a structure having a totally uniform thickness, but aspects of the present disclosure are not limited thereto. For example, the vibration member 100 may include a plate structure having a totally uniform thickness, but aspects of the present disclosure are not limited thereto.

The vibration member 100 according to another aspect of the present disclosure may include a vibration plate which includes a metal material or a nonmetal material (or a composite nonmetal material) having a material characteristic suitable for outputting a sound based on a vibration. The vibration member 100 may be configured to be transparent, translucent, or opaque. The metal material of the vibration member 100 may include one or more materials of stainless steel, aluminum (Al), an Al alloy, a magnesium (Mg), a Mg alloy, and a magnesium-lithium (Mg—Li) alloy, but aspects of the present disclosure are not limited thereto. The nonmetal material (or the composite nonmetal material) of the vibration member 100 may include one or more material (or substance) of plastic, fiber, leather, wood, cloth, rubber, carbon, glass, and paper, but aspects of the present disclosure are not limited thereto. For example, the paper may be cone paper for speakers. For example, the cone paper may be a pulp or a foamed plastic, or the like, but aspects of the present disclosure are not limited thereto.

The plastic material of the vibration member 100 according to an aspect of the present disclosure may be configured as polyethylene terephthalate (PET), polycarbonate (PC), polyimide (PI), polypropylene (PP), polyarylate (PAR), polyethersulfone (PES), polyethylene naphthalate (PEN), polysulfone (PSF), cyclo-olefin copolymer (COC), or carbon fiber reinforced plastic (CFRP), or the like, but aspects of the present disclosure are not limited thereto.

The vibration member 100 according to another aspect of the present disclosure may be configured in a plastic material of styrene material, but aspects of the present disclosure are not limited thereto. For example, the styrene material may be an ABS material. The ABS material may be acrylonitrile, butadiene, and styrene.

The vibration member 100 according to an aspect of the present disclosure may include a porous material. For example, the vibration member 100 may include a micro cellular plastic material. For example, the vibration member 100 may be configured as a polyethylene terephthalate (PET) material or a polycarbonate (PC) material. For example, the vibration member 100 may be configured as a Micro Cellular polyethylene terephthalate (MCPET) material. The vibration member 100 configured the MCPET may have capability to reproduce a high original sound because having a low density and an excellent elastic force, thereby enhancing the quality of a sound.

The vibration member 100 according to another aspect of the present disclosure may implement or realize a signage panel such as an analog signage or a digital signage, or the like such as an advertising signboard, a poster, or a noticeboard, or the like. For example, when the vibration member 100 implements the signage panel, the analog signage may include signage content such as a sentence, a picture, and a sign, or the like. The signage content may be disposed at the vibration member 100 to be visible. For example, the signage content may be attached on one or more of the first surface 100a and the second surface 100b of the vibration member 100. For example, the signage content may be directly attached on one or more of the first surface 100a and the second surface 100b of the vibration member 100. For example, the signage content may be printed on a medium such as paper or the like, and the medium with the signage content printed thereon may be directly attached on one or more of the first surface 100a and the second surface 100b of the vibration member 100. For example, when the signage content is attached on the second surface 100b of the vibration member 100, the vibration member 100 may be configured as a transparent material.

The supporting member 300 may be configured or disposed at the second surface 100b of the vibration member 100. The supporting member 300 may be configured to cover or surround the second surface 100b of the vibration member 100, thereby accommodating all of the elements of the apparatus 10 including the vibration member 100 and the vibration apparatus 500.

The supporting member 300 according to an aspect of the present disclosure may include an internal space 300s which covers the second surface 100b of the vibration member 100. For example, the supporting member 300 may include a box shape where one side (or one portion or an upper side or an upper portion) of the internal space 300s is opened. For example, the supporting member 300 may be a case, an outer case, a case member, a housing, a housing member, a cabinet, an enclosure, a sealing member, a sealing cap, a sealing box, or a sound box, or the like, but aspects of the present disclosure are not limited thereto. For example, the internal space 300s of the supporting member 300 may be an accommodation space, a receiving space, a gap space GS, an air space, a vibration space, a sound space, a sound box, or a sealing space, or the like, but aspects of the present disclosure are not limited thereto.

The supporting member 300 according to an aspect of the present disclosure may include one or more of a metal material and a nonmetal material (or a composite nonmetal material), but aspects of the present disclosure are not limited thereto. For example, the supporting member 300 may include one or more materials of a metal material, plastic, and wood, but aspects of the present disclosure are not limited thereto. For example, the supporting member 300 may configure as a metal material such as aluminum (Al) material or a plastic material such as plastic or styrene material, but aspects of the present disclosure are not limited thereto.

The supporting member 300 according to an aspect of the present disclosure may include a first supporting part 310 and a second supporting part 330.

The first supporting part 310 may be disposed in parallel with the vibration member 100. The first supporting part 310 may be disposed to face the second surface 100b of the vibration member 100. The first supporting part 310 may be disposed to cover the second surface 100b of the vibration member 100. The first supporting part 310 may be spaced apart from the second surface 100b of the vibration member 100. For example, the first supporting part 310 may be spaced apart from the second surface 100b of the vibration member 100 with the internal space 300s therebetween. For example, the first supporting part 310 may be a floor part, a bottom part, a floor plate, a bottom plate, a supporting plate, a housing plate, a housing floor part, or a housing bottom part, or the like, but aspects of the present disclosure are not limited thereto.

The second supporting part 330 may be connected to a periphery portion of the first supporting part 310. For example, the second supporting part 330 may include a structure bent from the periphery portion of the first supporting part 310. For example, the second supporting part 330 may be parallel to the third direction Z, or may be inclined from the third direction Z. For example, the second supporting part 330 may be a lateral part, a sidewall, a supporting sidewall, a housing lateral surface, or a housing sidewall, or the like, but aspects of the present disclosure are not limited thereto.

The second supporting part 330 may be configured to cover or surround the lateral surfaces 100c of the vibration member 100. Accordingly, the second supporting part 330 may configure an outermost lateral surface of the apparatus 10 or a lateral surface of a product.

The second supporting part 330 may be integrated into the first supporting part 310. For example, the first supporting part 310 and the second supporting part 330 may be integrated (or configured) as one body (or a single body), and thus, the internal space 300s surrounded by the second supporting part 330 may be provided over the first supporting part 310. Accordingly, the supporting member 300 may include a box shape where one side (or one portion or an upper side or an upper portion) is opened by the first supporting part 310 and the second supporting part 330.

The second supporting part 330 may have a single sidewall structure or a hemming structure. The hemming structure may be a structure where end portions of an arbitrary member are bent in a curve shape and overlap each other or are spaced apart from each other in parallel. For example, to enhance a sense of beauty in design, the second supporting part 330 may be configured to include a bending sidewall which is bent from the second supporting part 330. For example, the bending sidewall may include a first bending sidewall, bent from one side (or one portion or an end) of the second supporting part 330, and a second bending sidewall bent from the first bending sidewall to a region between the first bending sidewall and an outer surface of the vibration member 100. The second bending sidewall may be spaced apart from an inner surface of the first bending sidewall to prevent (or minimize) contact with the inner surface of the first bending sidewall or external impact in a lateral direction from being transmitted to the lateral surfaces 100c of the vibration member 100. Therefore, the second bending sidewall may prevent (or minimize) the lateral surfaces 100c of the vibration member 100 from contacting an inner surface of the first bending sidewall or may prevent an external impact of a lateral direction from being transferred to the lateral surfaces 100c of the vibration member 100.

The apparatus 10 according to an aspect of the present disclosure may include a coupling member 200 between the vibration member 100 and the supporting member 300. The supporting member 300 may be coupled to or connected to the vibration member 100 by the coupling member 200.

The supporting member 300 may be connected to or coupled to a periphery portion of the vibration member 100 by the coupling member 200. The supporting member 300 may be connected to or coupled to the second surface 100b of the vibration member 100 by the coupling member 200. For example, the supporting member 300 may be connected to or coupled to a periphery portion of the second surface 100b of the vibration member 100 by the coupling member 200.

The coupling member 200 may be configured to minimize or prevent the transfer of a vibration of the vibration member 100 to the supporting member 300. The coupling member 200 may include a material characteristic suitable for blocking the vibration transferred from the vibration member 100 to the supporting member 300. For example, the coupling member 200 may include a material having elasticity (or Young's modulus). For example, the coupling member 200 may include a material having elasticity for vibration absorption (or impact absorption). The coupling member 200 according to an aspect of the present disclosure may be configured as polyurethane materials or polyolefin materials, but aspects of the present disclosure are not limited thereto. For example, the coupling member 200 may include one or more of an adhesive, a double-sided tape, a double-sided foam tape, a double-sided foam pad, and a double-sided cushion tape, but aspects of the present disclosure are not limited thereto.

The coupling member 200 according to an aspect of the present disclosure may prevent a physical contact (or friction) between the vibration member 100 and the second supporting part 330 of the supporting member 300, and thus, may prevent the occurrence of noise (or a noise sound) caused by the physical contact (or friction) between the vibration member 100 and the supporting member 300. For example, the coupling member 200 may be a buffer member, an elastic member, a damping member, a vibration absorption member, a vibration prevention member, or a vibration blocking member, but aspects of the present disclosure are not limited thereto.

The coupling member 200 according to another aspect of the present disclosure may be configured to minimize or prevent the transfer of a vibration of the vibration member 100 to the supporting member 300 and to decrease the reflection of a sound wave which is generated and input based on a vibration of the vibration member 100.

The coupling member 200 according to another aspect of the present disclosure may include a first coupling member 210 and a second coupling member 230.

The first coupling member 210 may be disposed between the vibration member 100 and the supporting member 300. The first coupling member 210 may be disposed or coupled between a rear periphery portion of the vibration member 100 and a first supporting part 310 of the supporting member 300. For example, the first coupling member 210 may be disposed inward (or an inner portion) of the second coupling member 230. The first coupling member 210 may be configured to have hardness which is smaller than that of the second coupling member 230, for example, a modulus (or a Young's modulus). For example, the first coupling member 210 may include a double-sided polyurethane tape, a double-sided polyurethane foam tape, a double-sided sponge tape, or the like, but aspects of the present disclosure are not limited thereto.

The second coupling member 230 may be disposed between the vibration member 100 and the supporting member 300 to surround the first coupling member 210. The second coupling member 230 may be disposed or coupled between the rear periphery portion of the vibration member 100 and the first supporting part 310 of the supporting member 300 to surround the first coupling member 210. For example, the second coupling member 230 may be disposed outward (or an outer portion) from the first coupling member 210 and may be surrounded by the second supporting part 330 of the supporting member 300. The second coupling member 230 may be configured to have hardness which is greater than that of the first coupling member 210, for example, a modulus (or a Young's modulus). For example, the second coupling member 230 may include a double-sided polyolefin tape, a double-sided polyolefin foam tape, a double-sided acrylic tape, a double-sided acrylic foam tape, or the like, but aspects of the present disclosure are not limited thereto.

The coupling member 200 according to another aspect of the present disclosure may absorb a sound which is generated and input based on a vibration of the vibration member 100 by the first coupling member 210 which is relatively soft and is disposed inward from the second coupling member 230 which is relatively harder (or stiff), and thus, a reflected sound (or a reflected wave) generated by being reflected from the coupling member 200 may be minimized.

Accordingly, each of a highest sound pressure level and a lowest sound pressure level generated in a reproduction frequency band of a sound generated based on a vibration of the vibration member 100 may be reduced, and thus, flatness of a sound pressure level may be enhanced.

According to another aspect of the present disclosure, the supporting member 300 may be configured to support the rear periphery portion of the vibration member 100. For example, the supporting member 300 may be connected to the rear periphery portion of the vibration member 100 by the coupling member 200. For example, the second supporting part 330 of the supporting member 300 may be connected to the rear periphery portion of the vibration member 100 by the coupling member 200. Accordingly, the lateral surface 100c of the vibration member 100 may be exposed to the outside without being covered by the supporting member 300, and a size of the apparatus 10 may be reduced.

The vibration apparatus 500 may be configured to vibrate the vibration member 100. The vibration apparatus 500 may be configured at the internal space 300s or a gap space GS to vibrate the vibration member 100. The vibration apparatus 500 may vibrate the vibration member 100 to output a first sound S1a or a first haptic feedback in a forward direction (or first sound output direction) SOD1 of the vibration member 100. The vibration apparatus 500 may be disposed or configured at the vibration member 100. The vibration apparatus 500 may be configured to vibrate (or displace or drive) based on a driving signal (or an electrical signal or a voice signal) applied thereto to vibrate (or displace) the vibration member 100. For example, the vibration apparatus 500 may be an active vibration member, a vibration generator, a vibration structure, a vibrator, a vibration generating device, a sound generator, a sound device, a sound generating structure, or a sound generating device, but aspects of the present disclosure are not limited thereto.

The vibration apparatus 500 according to an aspect of the present disclosure may include a piezoelectric material or an electroactive material which have a piezoelectric characteristic. The vibration apparatus 500 may autonomously vibrate (or displace) based on a vibration (or displacement or driving) of the piezoelectric material based on a driving signal applied to the piezoelectric material, or may vibrate (or displace or drive) the vibration member 100 or the like. The vibration apparatus 500 may alternately repeat contraction and/or expansion based on a piezoelectric effect (or a piezoelectric characteristic) to vibrate (or displace or drive). For example, the vibration apparatus 500 may vibrate (or displace or drive) in a vertical direction (or a thickness direction) Z as contraction and/or expansion are alternately repeated by an inverse piezoelectric effect.

The vibration apparatus 500 according to an aspect of the present disclosure may include a tetragonal shape which has a first length parallel to the first direction X and a second length parallel to the second direction Y. For example, the vibration apparatus 500 may include a tetragonal shape which has where the first length is greater than that of the second length. For example, the vibration apparatus 500 may include a tetragonal shape which has where the first length is twice (or two times) the second length, but aspects of the present disclosure are not limited thereto.

The vibration apparatus 500 according to an aspect of the present disclosure may be connected to or coupled to the vibration member 100 by a connection member 400. For example, the vibration apparatus 500 may be connected to or supported by the second surface 100b of the vibration member 100 by the connection member 400, but aspects of the present disclosure are not limited thereto. For example, the connection member 400 may be a first connection member, an adhesive member, or a first adhesive member, but aspects of the present disclosure are not limited thereto.

The connection member 400 may be disposed between the vibration apparatus 500 and the vibration member 100 and may connect or couple the vibration apparatus 500 to the vibration member 100. For example, the vibration apparatus 500 may be connected or coupled to the second surface 100b of the vibration member 100 by the connection member 400, and thus, the vibration apparatus 500 may be supported by or disposed at the second surface 100b of the vibration member 100.

The connection member 400 according to an aspect of the present disclosure may include an adhesive layer (or a tacky layer) which is good in attaching force or adhesive force. For example, the connection member 400 may be configured as a material including an adhesive layer which is good in attaching force or adhesive force, with respect to each of the vibration apparatus 500 and the second surface 100b of the vibration member 100. For example, the connection member 400 may include a foam pad, a double-sided tape, a double-sided foam pad, a double-sided foam tape, an adhesive, a double-sided adhesive tape, a double-sided adhesive foam pad, or a tacky sheet, or the like, but aspects of the present disclosure are not limited thereto. For example, when the connection member 400 includes the adhesive layer (or the tacky layer), the connection member 400 may include only an adhesive layer or a tacky layer without a base member such as a plastic material or the like.

The adhesive layer (or a tacky layer) of the connection member 400 according to an aspect of the present disclosure may include epoxy, acrylic, silicone, or urethane, but aspects of the present disclosure are not limited thereto. The adhesive layer (or a tacky layer) of the connection member 400 according to another aspect of the present disclosure may include a pressure sensitive adhesive (PSA), an optically cleared adhesive (OCA), or an optically cleared resin (OCR), but aspects of the present disclosure are not limited thereto. For example, the adhesive layer of the connection member 400 may include an acrylic-based a substance (or a material) having a characteristic where an adhesive force is relatively better and hardness is higher than the urethane material. Accordingly, a vibration of the vibration apparatus 500 may be efficiently transferred to the vibration member 100.

The connection member 400 according to an aspect of the present disclosure may include one or more of a thermo-curable adhesive, a photo-curable adhesive, and a thermosetting adhesive (or a thermal bonding adhesive). For example, the connection member 400 may include the thermosetting adhesive. The thermosetting adhesive may be a heat-active type or a thermo-curable type. For example, the connection member 400 including the thermosetting adhesive may attach or couple the vibration apparatus 500 and the vibration member 100 by heat and pressure.

In the apparatus 10 according to an aspect of the present disclosure, the vibration member 100 may include a first region A1 and a second region A2. For example, the second surface 100b of the vibration member 100 may include a first region (or a first rear region) A1 and a second region (or a second rear region) A2. For example, the first region A1 may be a left rear region, and the second region A2 may be a right rear region. The first region A1 and the second region A2 may be a left-right symmetrical with respect to a center line CL of the vibration member 100 based on the first direction X, but aspects of the present disclosure are not limited thereto, and the first region A1 and the second region A2 may be a left-right asymmetrical. For example, when the vibration member 100 is a display panel having a plurality of pixels, each of the first region A1 and the second region A2 may overlap a display area of the display panel.

With reference to FIGS. 2 to 4, the apparatus 10 or the vibration apparatus 500 according to an aspect of the present disclosure may include a first vibration apparatus 500-1 and a second vibration apparatus 500-2.

The first vibration apparatus 500-1 may be configured to vibrate the first region A1 of the vibration member 100. The first vibration apparatus 500-1 may be disposed at the first region A1 of the vibration member 100. The first vibration apparatus 500-1 may be connected to or coupled to the first region A1 of the vibration member 100 by the connection member 400, and thus, the first vibration apparatus 500-1 may be connected to or supported by the first region A1 of the vibration member 100. The first vibration apparatus 500-1 may be connected to or supported by the second surface 100b of the vibration member 100 overlapping the first region A1 of the vibration member 100 by the connection member 400. For example, the first vibration apparatus 500-1 may be disposed close to a center portion or a periphery within the first region A1 of the vibration member 100 with respect to the first direction X. The first vibration apparatus 500-1 may vibrate the first region A1 of the vibration member 100, and thus, the first vibration apparatus 500-1 may generate a first sound S1a or a first haptic feedback in the first region A1 of the vibration member 100. For example, the first vibration apparatus 500-1 may directly vibrate the first region A1 of the vibration member 100, and thus, the first vibration apparatus 500-1 may generate the first sound S1a or the first haptic feedback in the first region A1 of the vibration member 100. For example, the first sound S1a may be a left sound (or a right sound).

The second vibration apparatus 500-2 may be configured to vibrate the second region A2 of the vibration member 100. The second vibration apparatus 500-2 may be disposed at the second region A2 of the vibration member 100. The second vibration apparatus 500-2 may be connected to or coupled to the second region A2 of the vibration member 100 by the connection member 400, and thus, the second vibration apparatus 500-2 may be connected to or supported by the second region A2 of the vibration member 100. The second vibration apparatus 500-2 may be connected to or supported by the second surface 100b of the vibration member 100 overlapping the second region A2 of the vibration member 100 by the connection member 400. For example, the second vibration apparatus 500-2 may be disposed close to a center portion or a periphery within the second region A2 of the vibration member 100 with respect to the first direction X. The second vibration apparatus 500-2 may vibrate the second region A2 of the vibration member 100, and thus, the second vibration apparatus 500-2 may generate a second sound S2a or a second haptic feedback in the second region A2 of the vibration member 100. For example, the second vibration apparatus 500-2 may directly vibrate the second region A2 of the vibration member 100, and thus, the second vibration apparatus 500-2 may generate the second sound S2a or the second haptic feedback in the second region A2 of the vibration member 100. For example, the second sound S2a may be a right sound (or a left sound).

The apparatus 10 or the supporting member 300 according to an aspect of the present disclosure may further include a plurality of holes 300h.

The plurality of holes 300h may be configured for decreasing an internal air pressure of the apparatus 10. For example, the plurality of holes 300h may be configured for reducing an air pressure of the internal space 300s of the apparatus 10 or an air pressure of the internal space 300s provided between the vibration member 100 and the supporting member 300.

The plurality of holes 300h may be configured at the supporting member 300. The plurality of holes 300h may be configured at a certain region or a partial region of the supporting member 300. The plurality of holes 300h may be formed to pass through or vertically pass through the supporting member 300. Therefore, the internal space 300s of the apparatus 10 or the internal space 300s provided between the vibration member 100 and the supporting member 300 may be connected or communicate with the outside by the plurality of holes 300h, and thus, an air pressure of the internal space 300s of the apparatus 10 or an air pressure of the internal space 300s provided between the vibration member 100 and the supporting member 300 may be reduced. For example, when the supporting member 300 is a housing, the internal space 300s surrounded by the vibration member 100 and the housing may be connected to or communicate with an external space of the housing through the plurality of holes 300h.

The plurality of holes 300h may each be a path through which a sound generated based on a vibration of the vibration member 100 (or the vibration apparatus 500) is output in a rearward direction (or a second sound output direction) SOD2 of the apparatus 10 or the supporting member 300. The sound generated based on the vibration of the vibration member 100 (or the vibration apparatus 500) may be output in the forward direction SOD1 of the vibration member 100 and may be output in a rearward direction SOD2 of the apparatus 10 or the supporting member 300 through the plurality of holes 300h. For example, a sound output in the forward direction SOD1 of the vibration member 100 may be first sounds (or forward sounds) S1a and S2a. For example, a sound output in the rearward direction SOD2 of the apparatus 10 or the supporting member 300 may be second sounds (or rearward sounds) S1b and S2b. Accordingly, the apparatus 10 according to an aspect of the present disclosure may output the sounds S1a, S1b, S2a, and S2b in the forward direction SOD1 and the rearward direction SOD2.

Each of the plurality of holes 300h may be configured at the supporting member 300 to overlap the vibration apparatus 500. Each of the plurality of holes 300h may be configured at the first supporting part 310 of the supporting member 300 to overlap the vibration apparatus 500. The plurality of holes 300h may be configured at a region, overlapping the vibration apparatus 500, of a region of the first supporting part 310. The plurality of holes 300h may be formed to pass through or vertically pass through the first supporting portion 310 along a thickness direction of the supporting member 300 or a third direction Z.

The plurality of holes 300h may be configured at the supporting member 300 overlapping each of the first region A1 and the second region A2 of the vibration member 100. The plurality of holes 300h may be configured at the first supporting part 310 of the supporting member 300 overlapping each of the first region A1 and the second region A2 of the vibration member 100.

The plurality of holes 300h may be configured at the supporting member 300 to overlap each of first and second vibration apparatuses 500-1 and 500-2 of the vibration apparatus 500. The plurality of holes 300h may be configured at the first supporting part 310 of the supporting member 300 to overlap each of first and second vibration apparatuses 500-1 and 500-2 of the vibration apparatus 500. Outermost holes of the plurality of holes 300h may be spaced apart from an end (or a side or one side or one portion) of the vibration apparatus 500.

The plurality of holes 300h according to an aspect of the present disclosure may be configured to have a certain interval (or a pitch or a distance) P at the first supporting part 310 of the supporting member 300. For example, the plurality of holes 300h may be configured to have the certain interval P along each of the first direction X and the second direction Y. For example, the interval (or a pitch or a distance) P between the plurality of holes 300h may be a shortest distance or a distance between center portions of two adjacent holes 300h. The plurality of holes 300h may have a same size. The size (or a diameter) of each of the plurality of holes 300h may be smaller than the interval (or a pitch or a distance) P between the plurality of holes 300h.

The supporting member 300 according to an aspect of the present disclosure may include one or more hole regions 350 including the plurality of holes 300h. The vibration apparatus 500 may overlap some (or a portion) of the plurality of holes 300h at the one or more hole regions 350. Some of the plurality of holes 300h may overlap the vibration apparatus 500, and the other (or remaining) of the plurality of holes 300h may be configured at a periphery of the vibration apparatus 500. A center portion of the vibration apparatus 500 may be spaced apart from a center portion of the hole region 350. For example, the one or more hole regions 350 may each include a first side (or a left side) and a second side (or a right side) located at the first direction X, and a third side (or an upper side) and a fourth side (or a lower side) located at the second direction Y. The center portion of the vibration apparatus 500 may be located or aligned at a center portion of the hole region 350.

The one or more hole regions 350 may be configured at the supporting member 300 to overlap each of the first and second vibration apparatuses 500-1 and 500-2 of the vibration apparatus 500. The one or more hole regions 350 may be configured at the first supporting part 310 of the supporting member 300 to overlap each of the first and second vibration apparatuses 500-1 and 500-2 of the vibration apparatus 500.

The supporting member 300 or the hole region 350 according to an aspect of the present disclosure may include a first hole region 351 and a second hole region 352.

Each of the first hole region 351 and the second hole region 352 may include a plurality of holes 300h. The first hole region 351 may be configured at the supporting member 300 to overlap the first vibration apparatus 500-1. The first hole region 351 may be configured at the first supporting part 310 of the supporting member 300 to overlap the first vibration apparatus 500-1. The second hole region 352 may be configured at the supporting member 300 to overlap the second vibration apparatus 500-2. The second hole region 352 may be configured at the first supporting part 310 of the supporting member 300 to overlap the second vibration apparatus 500-2.

Each of the first hole region 351 and the second hole region 352 may be configured to have a size corresponding to a size of the vibration apparatus 500, at a region of the first supporting part 310 of the supporting member 300. For example, each of the first hole region 351 and the second hole region 352 may include a square shape having a size which is greater than that of the vibration apparatus 500. The first hole region 351 may have a size which is greater than that of the first vibration apparatus 500-1. For example, a center portion of the first vibration apparatus 500-1 may be located or aligned at a center portion of the first hole region 351. The second hole region 352 may have a size which is greater than that of the second vibration apparatus 500-2. For example, a center portion of the second vibration apparatus 500-2 may be located or aligned at a center portion of the second hole region 352.

In each of the first hole region 351 and the second hole region 352, the number and density of holes 300h per unit area may be the same. Outermost holes of the plurality of holes 300h at each of the first hole region 351 and the second hole region 352 may be spaced apart from an end (or a side or one side or one portion) of the vibration apparatus 500. For example, each of the first hole region 351 and the second hole region 352 may be a hole arrangement region, a hole pattern, a hole pattern region, a hole pattern part, an air duct region, an air duct part, an air entrance region, an air inlet and outlet region, an air discharge region, an air pressure control region, or a vent area (or a vent region), but aspects of the present disclosure are not limited thereto.

According to an aspect of the present disclosure, the plurality of holes 300h may communicate (or connect) the internal space 300s of the apparatus 10 with an external space to reduce an air pressure of the internal space 300s, and thus, the plurality of holes 300h may increase or expand a band of a low-pitched sound band of sounds S1a and S2a generated based on a vibration of the vibration member 100, thereby improving a sound characteristic and/or a sound pressure level characteristic of the low-pitched sound band. For example, an air pressure (or pressure) of the internal space 300s of the apparatus 10 may be reduced by the plurality of holes 300h, and thus, the amount of displacement (or a bending force) of the vibration member 100 or the vibration apparatus 500 may increase, and thus, a band of the low-pitched sound band may increase or be expanded, thereby enhancing a sound characteristic and/or a sound pressure level characteristic of the low-pitched sound band.

According to another aspect of the present disclosure, in an apparatus in which the hole region 350 is not configured at the supporting member 300, a largest variation of pressure may occur in the internal space 300s where a volume variation is largest, based on a vibration of the vibration member 100 (or the vibration apparatus 500), and thus, the amount of displacement (or a bending force) of the vibration member 100 (or the vibration apparatus 500) may decrease, whereby a sound characteristic and/or a sound pressure level characteristic of the low-pitched sound band may decrease or be reduced. The internal space 300s in which the hole 350 is not configured at the supporting member 300 may be a closed internal space 300s. For example, in the apparatus including the closed internal space 300s, a pressure (or an air pressure) of the internal space 300s may increase based on a sound wave or a sound generated by a vibration of the vibration member 100 (or the vibration apparatus 500), and thus, the amount of displacement (or a bending force) of the vibration member 100 (or the vibration apparatus 500) may decrease, whereby a sound characteristic and/or a sound pressure level characteristic of the low-pitched sound band may decrease or be reduced.

The apparatus 10 or the vibration apparatus 500 according to an aspect of the present disclosure may further include an enclosure 600.

The enclosure 600 may be configured to surround the vibration apparatus 500. The enclosure 600 may be configured to surround the vibration apparatus 500 and the hole region 350. The enclosure 600 may be configured between the vibration member 100 and the supporting member 300. The enclosure 600 may be configured between the vibration member 100 and the supporting member 300 to surround the vibration apparatus 500. The enclosure 600 may be configured between the vibration member 100 and the supporting member 300 to surround the hole region 350. The enclosure 600 may be configured to provide a gap space GS between the vibration member 100 and a hole region 350 of the supporting member 300. The enclosure 600 may be spaced apart from the coupling member 200 and may be surrounded by the coupling member 200. Accordingly, the apparatus 10 according to an aspect of the present disclosure may further include a gap space GS configured between the vibration member 100, the supporting member 300, and the enclosure 600.

The enclosure 600 may be configured to limit (or define) a vibration region of the vibration member 100 based on a vibration (or displacement or driving) of the vibration apparatus 500. For example, the enclosure 600 may enlarge (or expand) the vibration region of the vibration member 100 and may be configured to enlarge (or expand) a wave generated based on the vibration (or displacement or driving) of the vibration apparatus 500. The enclosure 600 may limit and/or enlarge (or expand) the vibration region of the vibration member 100, and thus, the enclosure 600 may decrease a resonance frequency of the vibration member 100 and/or the vibration apparatus 500. For example, the vibration region of the vibration member 100 limited and/or enlarged (or expanded) by the enclosure 600 may act as a stiffness (or spring constant) k and a mass (or weight) m of the vibration member 100 and/or the vibration apparatus 500. For example, as in the following Equation 1, the vibration region of the vibration member 100 limited and/or enlarged (or expanded) by the enclosure 600 may decrease the stiffness (or spring constant) k of the vibration member 100 and/or the vibration apparatus 500 and may increase the mass (or weight) m of the vibration member 100 and/or the vibration apparatus 500, and thus, a resonance frequency f₀ of the vibration member 100 and/or the vibration apparatus 500 may decrease. Accordingly, a sound characteristic and/or a sound pressure level characteristic of a low-pitched sound band generated based on a vibration of the vibration member 100 may be enhanced.

$${f}_{0} = \frac{1}{2 π} \cdot \sqrt{\frac{k}{m}} ( Hz ) \qquad [ Equation 1 ]$$

The enclosure 600 according to an aspect of the present disclosure may include a polygonal ring shape surrounding the vibration apparatus 500 and the hole region 350. For example, the enclosure 600 may include a polygonal ring shape having a plurality of internal angles. For example, each of the plurality of internal angles in the enclosure 600 may be an obtuse angle. As an aspect of the present disclosure, the enclosure 600 may include a hexagonal ring shape. As another aspect of the present disclosure, as illustrated in FIG. 6, the enclosure 600 may include an octagonal ring shape. For example, the enclosure 600 may be configured in a polygonal ring shape including a hexagonal shape or an octagonal shape, and thus, may be disposed (or configured) to provide a vibration region which is approximately circular in shape or has a same distance with respect to a center portion of the vibration apparatus 500. For example, the vibration region provided by the enclosure 600 may be implemented as a vibration source (or a vibrator) which is approximately circular in shape, and thus, a non-uniform vibration within the vibration region may be minimized or prevented. Accordingly, a vibration characteristic of the vibration member 100 and/or the vibration apparatus 500 may be enhanced, or a sound pressure level characteristic of a low-pitched sound band generated (or output) by a vibration of the vibration member 100 based on a vibration of the vibration apparatus 500 may be enhanced.

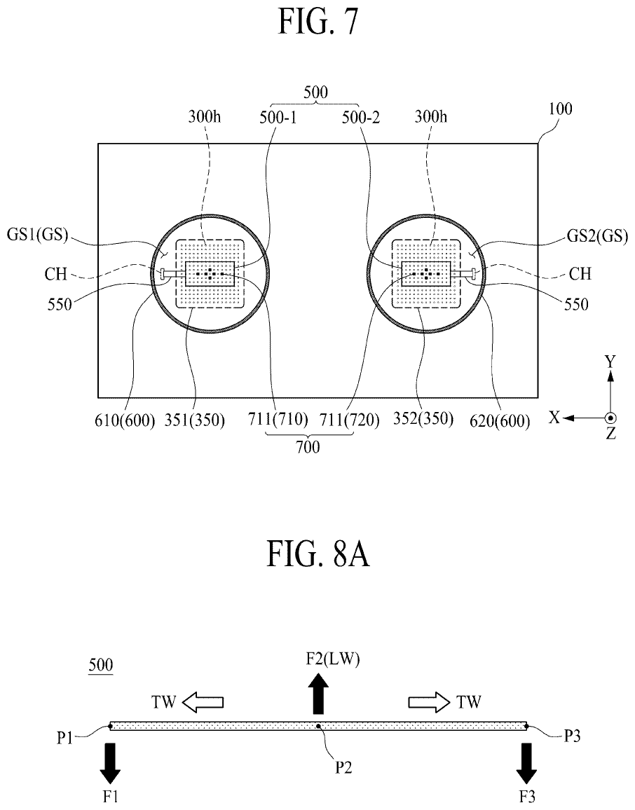

The enclosure 600 according to another aspect of the present disclosure, as illustrated in FIG. 7, may include a circular ring shape. The enclosure 600 including a circular ring shape may be disposed (or configured) to provide a vibration region which is a circular shape or has a same distance with respect to a center portion of the vibration apparatus 500. For example, the vibration region provided by the enclosure 600 may be implemented as a vibration source (or a vibrator) which is circular in shape, and thus, a non-uniform vibration within the vibration region may be minimized or prevented. Accordingly, a vibration characteristic of the vibration member 100 and/or the vibration apparatus 500 may be enhanced, or a sound pressure level characteristic of a low-pitched sound band generated (or output) by a vibration of the vibration member 100 based on a vibration of the vibration apparatus 500 may be enhanced.

With reference to FIGS. 2 to 4, the enclosure 600 may be configured between the vibration member 100 and the supporting member 300 to surround each of the first vibration apparatus 500-1 and the second vibration apparatus 500-2 of the vibration apparatus 500. The enclosure 600 may be configured between the vibration member 100 and the supporting member 300 to surround the first hole region 351 and the first vibration apparatus 500-1 of the vibration apparatus 500 and surround the second hole region 352 and the second vibration apparatus 500-2 of the vibration apparatus 500.

The enclosure 600 may separate or may minimize or prevent mutual interference a vibration (or a sound), generated in the first region A1 of the vibration member 100, from a vibration (or a sound) generated in the second region A2 of the vibration member 100. A left sound and a right sound generated based on vibrations of the first region A1 and the second region A2 of the vibration member 100 may be separated from each other by the enclosure 600, and thus, a sound output characteristic of the apparatus 10 may be more enhanced and the sounds S1a, S1b, S2a, and S2b including a 2-channel sound may be output in the forward direction SOD1 of the vibration member 100 and the rearward direction SOD2 of the supporting member 300, based on the separation of the left and right sounds. For example, the enclosure 600 may be a partition, a partition member, a sound blocking member, a sound separation member, a space separation member, or a baffle, or the like, but aspects of the present disclosure are not limited thereto.

The apparatus 10 according to an aspect of the present disclosure may further include a low-pitched sound band expander. For example, the low-pitched sound band expander may be configured to surround the vibration apparatus 500 and may be configured to optimize a vibration region of the vibration member 100 to increase a low-pitched sound band of the vibration apparatus 500. For example, the low-pitched sound band expander may be between the vibration member 100 and the supporting member 300 and may be configured to surround the vibration apparatus 500 and the plurality of holes 300h. For example, the low-pitched sound band expander may include the enclosure 600.

The enclosure (or the low-pitched sound band expander) 600 according to an aspect of the present disclosure may include a first enclosure 610 and a second enclosure 620.

The first enclosure 610 may be configured between the vibration member 100 and the supporting member 300 to surround the first vibration apparatus 500-1 of the vibration apparatus 500. The first enclosure 610 may be configured between the vibration member 100 and the supporting member 300 to surround the first hole region 351 and the first vibration apparatus 500-1. The first enclosure 610 may form a first gap space GS1 at a periphery (or around) of the first vibration apparatus 500-1.

The first enclosure 610 may limit or enlarge a vibration region of the vibration member 100 based on a vibration (or displacement or driving) of the first vibration apparatus 500-1, in the first region A1 of the vibration member 100. For example, the first enclosure (or a first low-pitched sound band expander) 610 may be configured to surround the vibration apparatus 500 and configured to optimize a vibration region of the vibration member 100 to increase a low-pitched sound band of the vibration apparatus 500. For example, the first enclosure 610 may include a circular shape or a polygonal ring shape surrounding the first vibration apparatus 500-1 and the first hole region 351. For example, the first enclosure 610 may include a polygonal ring shape having a plurality of internal angles. For example, each of the plurality of internal angles in the enclosure 600 may be an obtuse angle. For example, the first enclosure 610 may be configured in a polygonal ring shape including a hexagonal shape or an octagonal shape, or may be configured in a circular shape.

The second enclosure 620 may be configured between the vibration member 100 and the supporting member 300 to surround the second vibration apparatus 500-2 of the vibration apparatus 500. The second enclosure 620 may be configured between the vibration member 100 and the supporting member 300 to surround the second hole region 352 and the second vibration apparatus 500-2. The second enclosure 620 may form a second gap space GS2 at a periphery (or around) of the second vibration apparatus 500-2.

The second enclosure 620 may limit or enlarge a vibration region of the vibration member 100 based on a vibration (or displacement or driving) of the second vibration apparatus 500-2, in the second region A2 of the vibration member 100. For example, the second enclosure (or a second low-pitched sound band expander) 620 may be configured to surround the vibration apparatus 500 and configured to optimize a vibration region of the vibration member 100 to increase a low-pitched sound band of the vibration apparatus 500. For example, the second enclosure 620 may include a circular shape or a polygonal ring shape surrounding the second vibration apparatus 500-2 and the second hole region 352. For example, the second enclosure 620 may include a polygonal ring shape having a plurality of internal angles. Each of the plurality of internal angles in the second enclosure 620 may be an obtuse angle. For example, the second enclosure 620 may be configured in a polygonal ring shape including a hexagonal shape or an octagonal shape, or may be configured in a circular shape.

According to an aspect of the present disclosure, the first enclosure 610 may be configured to be symmetric (or horizontally symmetric or left-right symmetric) with respect to a center portion of the vibration member 100.

According to an aspect of the present disclosure, the enclosure 600, or the first enclosure 610 and the second enclosure 620 may configured with a material having elasticity which enables a certain degree of compression. For example, the enclosure 600, or the first enclosure 610 and the second enclosure 620 may be configured with polyurethane or polyolefin, but aspects of the present disclosure are not limited thereto. As another aspect of the present disclosure, the enclosure 600, or the first enclosure 610 and the second enclosure 620 may be configured with a single-sided tape, a single-sided foam tape, a single-sided foam pad, a double-sided tape, a double-sided foam tape, a double-sided foam pad, or the like, but aspects of the present disclosure are not limited thereto.

With reference to FIGS. 2 to 5, the apparatus 10 according to an aspect of the present disclosure may further include a pad member 700.

The pad member 700 may be in the gap space GS provided by the enclosure 600. The pad member 700 may be configured to prevent (or limit) or bind (or restrain) a vibration of the center portion of the vibration apparatus 500. For example, the pad member 700 may be configured to block a longitudinal wave component of a wave generated based on the vibration (or displacement or driving) of the vibration apparatus 500.

The pad member 700 may be connected to the hole region 350 of the supporting member 300 to support the center portion of the vibration apparatus 500. The pad member 700 may be between the center portion of the vibration apparatus 500 and the hole region 350 of the supporting member 300. The pad member 700 may include a material which is not deformed by the vibration (or displacement or driving) of the vibration apparatus 500. The pad member 700 may include a material which may prevent (or limit) or bind (or restrain) a vibration of the center portion of the vibration apparatus 500. For example, the pad member 700 may be configured in a plastic material or a metal material, but aspects of the present disclosure are not limited thereto.

The plastic material of the pad member 700 according to an aspect of the present disclosure may be configured as polyethylene terephthalate, polycarbonate, polyimide, polypropylene, polyarylate, polyethersulfone, polyethylene naphthalate, polysulfone, cyclo-olefin copolymer, or carbon fiber reinforced plastic (CFRP), or the like, but aspects of the present disclosure are not limited thereto.

The pad member 700 according to another aspect of the present disclosure may be configured in a plastic material of styrene material, but aspects of the present disclosure are not limited thereto.

The metal material of the pad member 700 according to an aspect of the present disclosure may include any one or more materials of stainless steel, aluminum (Al), an Al alloy, a magnesium (Mg), a Mg alloy, and a magnesium-lithium (Mg—Li) alloy, but aspects of the present disclosure are not limited thereto.

The pad member 700 according to an aspect of the present disclosure may be disposed (or configured) to cover one or more of a plurality of holes 300h at the hole region 350. The pad member 700 may cover one or more of the plurality of holes 300h at the hole region 350, and thus, the pad member 700 may decrease or adjust a sound characteristic and/or a sound pressure level characteristic of a high-pitched sound band in a pitched sound band of a sound generated based on a vibration of the vibration member 100 and may prevent external foreign materials from penetrating into the gap space GS through the one or more holes 300h.

The apparatus 10 according to an aspect of the present disclosure may further include a high-pitched sound band adjustor. For example, the high-pitched sound band adjustor may be configured to connect the vibration apparatus 500 and the supporting member 300 and may be configured to prevent the vibration of a center portion of the vibration apparatus 500 to decrease a high-pitched sound band of the vibration apparatus 500. For example, the high-pitched sound band adjustor may include the pad member 700.

The pad member (or the high-pitched sound band adjustor) 700 according to an aspect of the present disclosure may be connected to one or more of the supporting member 300 and a rear surface 500r of the vibration apparatus 500. For example, the pad member 700 may be connected to one or more of the supporting member 300 and the rear surface 500r of the vibration apparatus 500 by an adhesive member 800.

The adhesive member 800 according to an aspect of the present disclosure may include a first adhesive member 810.

The first adhesive member 810 may be between the pad member 700 and the supporting member 300. The first adhesive member 810 may be between a first side (or rear surface or lower surface) of the pad member 700 and the hole region 350 of the supporting member 300. The pad member 700 may be adhered (or connected) to the hole region 350 of the supporting member 300 by the first adhesive member 810. For example, the first side of the pad member 700 may be adhered (or connected) to the hole region 350 of the supporting member 300 by the first adhesive member 810.

According to an aspect of the present disclosure, the pad member 700 may be adhered (or connected) to the hole region 350 by the first adhesive member 810 and may be attached or adhered to the rear surface 500r of the vibration apparatus 500. For example, a second side (or front surface or upper surface) of the pad member 700 may be attached or adhered to the rear surface 500r of the vibration apparatus 500. Accordingly, the pad member 700 may prevent (or limit) or bind (or restrain) a vibration of the center portion of the vibration apparatus 500. For example, the pad member (or high-pitched sound band adjustor) 700 may connect the vibration apparatus and the supporting member and may prevent the vibration of the center portion of the vibration apparatus 500 to decrease a high-pitched sound band of the vibration apparatus 500.

The adhesive member 800 according to an aspect of the present disclosure may further include a second adhesive member 820.

The second adhesive member 820 may be between the pad member 700 and the vibration apparatus 500. The second adhesive member 820 may be between the second side (or front surface or upper surface) of the pad member 700 and the rear surface 500r of the vibration apparatus 500. The pad member 700 may be adhered (or connected) to the rear surface 500r of the vibration apparatus 500 by the second adhesive member 820.

According to another aspect of the present disclosure, the first side of the pad member 700 may be adhered (or connected) to the supporting member 300 or the hole region 350 by the first adhesive member 810, and the second side of the pad member 700 may be adhered (or connected) to the rear surface 500r of the vibration apparatus 500 by the second adhesive member 820. Accordingly, the pad member 700 may prevent (or limit) or bind (or restrain) a vibration of the center portion of the vibration apparatus 500. For example, the pad member (or high-pitched sound band adjustor) 700 may connect the vibration apparatus 500 and the supporting member 300 and may prevent the vibration of the center portion of the vibration apparatus 500 to decrease a high-pitched sound band of the vibration apparatus 500.

According to an aspect of the present disclosure, the pad member 700 may be surrounded by the enclosure (or the low-pitched sound band expander) 600. For example, the enclosure (or the low-pitched sound band expander) 600 may be between the vibration member 100 and the supporting member 300 and may surround the vibration apparatus 500 and the pad member (or high-pitched sound band adjustor) 700. For example, the enclosure (or the low-pitched sound band expander) 600 may surround the vibration apparatus 500, the pad member (or high-pitched sound band adjustor) 700, and the plurality of holes 300h in a region between the vibration member 100 and the supporting member 300.

The adhesive layer of the adhesive member 800 or the first and second adhesive members 810 and 820 according to an aspect of the present disclosure may include epoxy, acrylic, silicone, or urethane, but aspects of the present disclosure are not limited thereto. For example, the adhesive layer of the adhesive member 800 or the first and second adhesive members 810 and 820 may include an acrylic-based a substance (or a material) having a characteristic where an adhesive force is relatively better and hardness is higher than the urethane material. Accordingly, the vibration of the center portion of the vibration apparatus 500a may be suppressed (or limited) or bound (or restrained).

The adhesive member 800 or the first and second adhesive members 810 and 820 according to another aspect of the present disclosure may include one or more of a thermo-curable adhesive, a photo-curable adhesive, and a thermosetting adhesive (or a thermal bonding adhesive). For example, the adhesive member 800 or the first and second adhesive members 810 and 820 may include the thermosetting adhesive. The thermosetting adhesive may be a heat-active type or a thermo-curable type.

The pad member 700 according to an aspect of the present disclosure may include a plurality of pads 711. The pad member 700 may include a plurality of pads 711 which support the center portion of the vibration apparatus 500.

The plurality of pads 711 may be between the vibration apparatus 500 and the hole region 350 of the supporting member 300. The plurality of pads 711 may be disposed (or configured) to have a predetermined interval or to be spaced apart from one another. For example, the plurality of pads 711 may be disposed (or configured) between the center portion of the vibration apparatus 500 and the hole region 350 of the supporting member 300 to have a predetermined interval or to be spaced apart from one another. Accordingly, the plurality of pads 711 may prevent (or limit) or bind (or restrain) the vibration of the center portion of the vibration apparatus 500.

One or more of the plurality of pads 711 may be disposed (or configured) to cover one or more of the plurality of holes 300h. A size D2 of each of the plurality of pads 711 may be greater than a size D1 of each of the plurality of holes 300h. For example, each of the plurality of pads 711 may be disposed (or configured) to cover one or more of the plurality of holes 300h. For example, each of the plurality of pads 711 may be configured to have a size capable of covering one hole 300h. The size D2 of one pad 711 may be smaller than a pitch P between the plurality of holes 300h.

Each of the plurality of pads 711 according to an aspect of the present disclosure may include a polygonal pillar shape or a circular pillar shape, but aspects of the present disclosure are not limited thereto.

Each of the plurality of pads 711 according to an aspect of the present disclosure may be adhered (or connected) to the supporting member 300 or the hole region 350 by the first adhesive member 810 and may be attached or adhered to the rear surface 500r of the vibration apparatus 500. Each of the plurality of pads 711 according to another aspect of the present disclosure may be adhered (or connected) to the supporting member 300 or the hole region 350 by the first adhesive member 810 and may be adhered (or connected) to the rear surface 500r of the vibration apparatus 500 by the second adhesive member 820.

The pad member 700 according to an aspect of the present disclosure may include a plurality of first pad members 710 and a plurality of second pad members 720.

The plurality of first pad members 710 may be between the first hole region 351 of the supporting member 300 and the first vibration apparatus 500-1. The plurality of first pad members 710 may be disposed (or configured) between the first hole region 351 and the first vibration apparatus 500-1 to be spaced apart from one another. The plurality of first pad members 710 may be disposed between the first hole region 351 and the rear surface 500r of the first vibration apparatus 500-1 to support the center portion of the first vibration apparatus 500-1. The plurality of first pad members 710 may be attached (or connected) to the supporting member 300 or the first hole region 351 by the first adhesive member 810 and may contact (or be adhered) to the rear surface 500r of the vibration apparatus 500 or may be attached (or connected) to the rear surface 500r of the vibration apparatus 500 by the second adhesive member 820. One or more of the plurality of first pad members 710 may cover the one or more holes 300h which are in the first hole region 351.

The plurality of first pad members 710 may include a plurality of pads 711 between the first vibration apparatus 500-1 and the first hole region 351. For example, the plurality of pads 711 may be disposed (or configured) between the center portion of the first vibration apparatus 500-1 and the first hole region 351 to have a predetermined interval or to be spaced apart from one another. One or more of the plurality of pads 711 may cover the one or more holes 300h which are in the first hole region 351. Accordingly, the plurality of first pad members 710 or the plurality of pads 711 may prevent (or limit) or bind (or restrain) the vibration of the center portion of the first vibration apparatus 500-1.

The plurality of second pad members 720 may be between the second hole region 352 of the supporting member 300 and the second vibration apparatus 500-2. The plurality of second pad members 720 may be disposed (or configured) between the second hole region 352 and the second vibration apparatus 500-2 to be spaced apart from one another. The plurality of second pad members 720 may be disposed between the second hole region 352 and the rear surface 500r of the second vibration apparatus 500-2 to support the center portion of the second vibration apparatus 500-2. The plurality of second pad members 720 may be attached (or connected) to the supporting member 300 or the second hole region 352 by the first adhesive member 810 and may contact (or be adhered) to the rear surface 500r of the vibration apparatus 500 or may be attached (or connected) to the rear surface 500r of the vibration apparatus 500 by the second adhesive member 820. One or more of the plurality of second pad members 720 may cover the one or more holes 300h which are in the second hole region 352.

The plurality of second pad members 720 may include a plurality of pads 711 between the second vibration apparatus 500-2 and the second hole region 352. For example, the plurality of pads 711 may be disposed (or configured) between the center portion of the second vibration apparatus 500-2 and the second hole region 352 to have a predetermined interval or to be spaced apart from one another. One or more of the plurality of pads 711 may cover the one or more holes 300h which are in the second hole region 352. Accordingly, the plurality of second pad members 720 or the plurality of pads 711 may prevent (or limit) or bind (or restrain) the vibration of the center portion of the second vibration apparatus 500-2.

The pad member 700 or the plurality of pads 711 may decrease the resonance frequency of the vibration member 100 and/or the vibration apparatus 500. For example, the pad member 700 or the plurality of pads 711 may contact or be connected to the center portion of the vibration apparatus 500 or each of the first and second vibration apparatuses 500-1 and 500-2, and thus, the pad member 700 or the plurality of pads 711 may act as a stiffness (or spring constant) k and a mass (or weight) m of the vibration member 100 and/or the vibration apparatus 500. For example, as in Equation 1 described above, the pad member 700 or the plurality of pads 711 may decrease the stiffness (or spring constant) k of the vibration member 100 and/or the vibration apparatus 500 and may increase the mass (or weight) m of the vibration member 100 and/or the vibration apparatus 500, and thus, the resonance frequency f₀ of the vibration member 100 and/or the vibration apparatus 500 may decrease. Accordingly, a sound characteristic and/or a sound pressure level characteristic of a low-pitched sound band generated based on a vibration of the vibration member 100 may be more enhanced.

The apparatus 10 according to an aspect of the present disclosure may include an open-type internal space 300s based on the plurality of holes 300h, and thus, a band of the low-pitched sound band may be expanded, a sound characteristic and/or a sound pressure level characteristic of the low-pitched sound band may be improved, and sounds S1a, S1b, S2a, and S2b generated based on the vibration of the vibration member 100 (or the vibration apparatus 500) may be output in a forward direction SOD1 of the vibration member 100 and a rearward direction SOD2 of the supporting member 300.

Moreover, the apparatus 10 according to an aspect of the present disclosure may include a vibration region having a polygonal shape or a circular shape, based on the enclosure 600 surrounding the vibration apparatus 500, and thus, a sound characteristic and/or a sound pressure level characteristic of a low-pitched sound band (for example, a low-pitched sound band of 200 Hz to 1 kHz) generated based on a vibration (or displacement) of the vibration apparatus 500 may be enhanced. Further, in the apparatus 10 according to an aspect of the present disclosure, a vibration (or displacement) of the center portion of the vibration apparatus 500 may be reduced (or prevented) by the pad member 700, and thus, the sound characteristic and/or sound pressure level characteristic of the low-pitched sound band (for example, the low-pitched sound band of 200 Hz to 1 kHz) generated based on the vibration (or displacement) of the vibration apparatus 500 may be further enhanced.

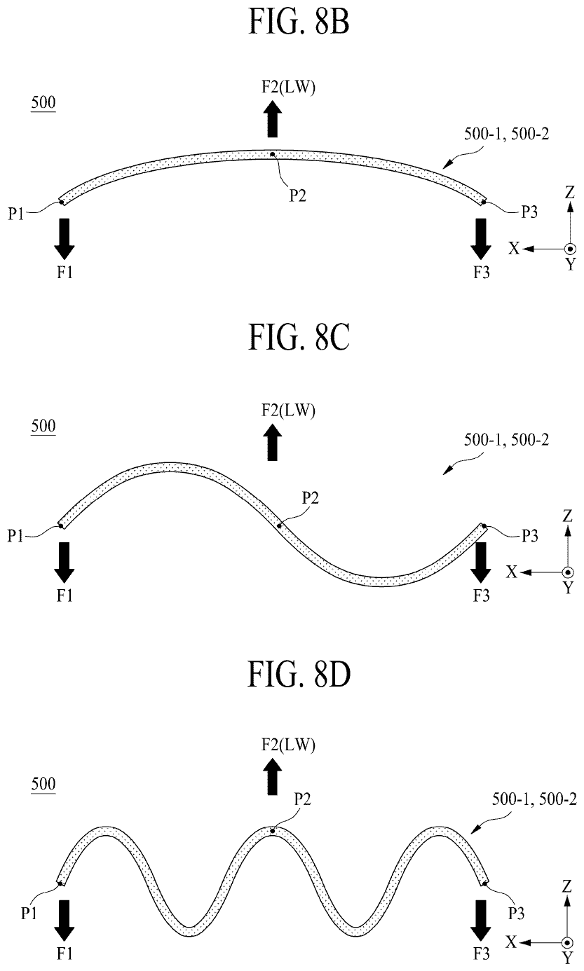

FIG. 8A illustrates an exciting force of a vibration apparatus according to an aspect of the present disclosure. FIG. 8B illustrates a first-order mode shape of the vibration apparatus according to an aspect of the present disclosure. FIG. 8C illustrates a second-order mode shape of the vibration apparatus according to an aspect of the present disclosure. FIG. 8D illustrates an n-order mode shape of the vibration apparatus according to an aspect of the present disclosure. In the following description, a “vibration apparatus 500 (or first and second vibration apparatuses 500-1 and 500-2)” may be referred to as a “vibration apparatus 500”.

With reference to FIG. 8A, the vibration apparatus 500 may alternately repeat contraction and/or expansion to vibrate (or displace), based on an inverse piezoelectric effect. The vibration apparatus 500 may include an in-plane vibration and an out-plane vibration. Waves based on a vibration of the vibration apparatus 500 may include longitudinal waves LW based on in the out-plane vibration and transverse waves TW based on the in-plane vibration. For example, the longitudinal waves LW may be waves where a vibration direction of a medium is a same as a traveling direction of a wave, and the transverse waves TW may be waves where a vibration direction of a medium is perpendicular to a traveling direction of a wave. For example, the vibration apparatus 500 may include a piezoelectric material having a piezoelectric characteristic, and thus, the transverse wave TW component of waves may be stronger than the longitudinal wave LW component of waves.

With reference to FIGS. 8A to 8D, according to an aspect of the present disclosure, the vibration apparatus 500 may include a first exciting point P1 corresponding to a first end, a second exciting point P2 corresponding to a center portion, and a third exciting point P3 corresponding to a second end opposite to the first end. A total exciting force “Ftotal=F1+F2+F3” of the vibration apparatus 500 may be a sum of first to third exciting forces F1, F2, and F3 of the first to third exciting points P1, P2, and P3 based on a vibration order-based mode shape (or mode shape or modal analysis).

The vibration apparatus 500 may vibrate in a shape which does not vibrate (or displace) in any one direction and is bent, and thus, comparing with the first and third exciting forces F1 and F3 at first and second ends of the vibration apparatus 500, the second exciting force F2 at the center portion of the vibration apparatus 500 may decrease the total exciting force Ftotal of the vibration apparatus 500. Further, the longitudinal waves LW generated based on a vibration (or displacement) of the vibration apparatus 500 may decrease an exciting force (or a displacement force) of the vibration apparatus 500, and due to this, a sound characteristic and/or a sound pressure level characteristic of a low-pitched sound band of the vibration apparatus 500 may be reduced. For example, when the second exciting force F2 of the vibration apparatus 500 or a vibration (or displacement) of the center portion of the vibration apparatus 500 is suppressed (or bound), the first exciting force F1 and the third exciting force F3 of the vibration apparatus 500 may increase or be maximized, and thus, a sound characteristic and/or a sound pressure level characteristic of the low-pitched sound band (for example, the low-pitched sound band of 200 Hz to 1 kHz) generated based on a vibration of the vibration apparatus 500 may be enhanced.

A vibration based on a displacement of the vibration apparatus 500 may include an in-phase component and an anti-phase component. For example, the in-phase component may contribute to increase a sound pressure level output, and the anti-phase component may contribute to decrease a sound pressure level output. For example, when an anti-phase component generated based on a vibration of the vibration apparatus 500 is reduced (or suppressed), a sound pressure level characteristic may be enhanced.

The second exciting force F2 of the center portion of the vibration apparatus 500 and/or the longitudinal waves LW generated based on a vibration (or displacement) of the vibration apparatus 500 may act as an anti-phase component. For example, when the second exciting force F2 of the vibration apparatus 500 or a vibration (or displacement) of the center portion of the vibration apparatus 500 is suppressed (or bound), an anti-phase component generated at the center portion of the vibration apparatus 500 may decrease. Accordingly, a sound characteristic and/or a sound pressure level characteristic of the low-pitched sound band (for example, the low-pitched sound band of 200 Hz to 1 kHz) generated based on the vibration (or displacement) of the vibration apparatus 500 may be enhanced.

According to the apparatus 10 according to an aspect of the present disclosure, as described above with reference to FIGS. 2 to 5, a vibration of the center portion of the vibration apparatus 500 may be suppressed (or bound) by the plurality of pads 711, and thus, an anti-phase component generated based on the vibration of the vibration apparatus 500 may be reduced (or suppressed). Accordingly, in the apparatus 10 according to an aspect of the present disclosure, a sound characteristic and/or a sound pressure level characteristic of the low-pitched sound band (for example, the low-pitched sound band of 200 Hz to 1 kHz) generated based on the vibration (or displacement) of the vibration apparatus 500 may be enhanced.

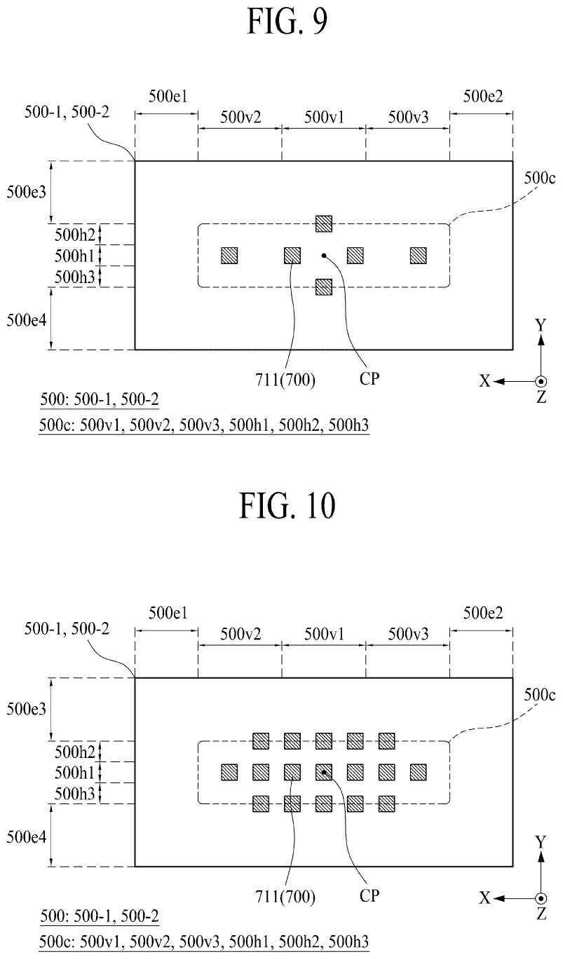

FIG. 9 illustrates an arrangement structure of a pad member according to an aspect of the present disclosure.

With reference to FIG. 9, a plurality of pads 711 (or a pad member 700) according to an aspect of the present disclosure may be disposed at a center portion 500c including a center point CP of a vibration apparatus 500 (or first and second vibration apparatuses 500-1 and 500-2). At least a portion of each of the plurality of pads 711 may be disposed (or located) at the center portion 500c of the vibration apparatus 500. For example, the center portion 500c of the vibration apparatus 500 may include the center point CP of a vibration apparatus 500 and may be a region including at least a portion of each of the plurality of pads 711. In the following description, “a plurality of pads 711 (or pad member 700)” may be referred to as “a plurality of pads 711”.

The vibration apparatus 500 may include the center portion 500c and periphery portions 500c1 to 500e4 surrounding the center portion 500c.

The center portion 500c of the vibration apparatus 500 may include a portion where an anti-phase component occurs when the vibration apparatus is vibrating (or displace). The center portion 500c of the vibration apparatus 500 may include the center point CP of the vibration apparatus 500. For example, the center portion 500c of the vibration apparatus 500 may have an area of 20% to 40%, including the center point CP, of a total area of the vibration apparatus 500. For example, a length (or a first length) of the center portion 500c parallel to a long side of the vibration apparatus 500 may have a length corresponding to ½ to ⅔ of a long-side length of the vibration apparatus 500, but aspects of the present disclosure are not limited thereto. A length (or a second length) of the center portion 500c parallel to a short side of the vibration apparatus 500 may have a length corresponding to ½ to ⅔ of a short-side length of the vibration apparatus 500, but aspects of the present disclosure are not limited thereto.

The vibration apparatus 500 may include first to fourth periphery portions 500e1 to 500c4.

The first periphery portion 500e1 may be a portion between a first side (or a first portion or a left side) of a center portion 500c1 of the vibration apparatus 500 and a first short side of the vibration apparatus 500. For example, the first periphery portion 500e1 may be a left periphery portion of the vibration apparatus 500. The second periphery portion 500c2 may be a portion between a second side (or a second portion or a right side) of the center portion 500c1 of the vibration apparatus 500 and a second short side of the vibration apparatus 500. For example, the second periphery portion 500c2 may be a right periphery portion of the vibration apparatus 500.

The first periphery portion 500e1 and the second periphery portion 500e2 may be parallel to each other with the center portion 500c therebetween. The first periphery portion 500e1 and the second periphery portion 500e2 may have a same size (or area). For example, a length (or a first length) of each the first periphery portion 500e1 and the second periphery portion 500c2 parallel to the short side of the vibration apparatus 500 may be equal to a short-side length of the vibration apparatus 500. A width (or a second length) of each the first periphery portion 500e1 and the second periphery portion 500c2 parallel to the long side of the vibration apparatus 500 may have a length corresponding to ¼ to ⅙ of a long-side length of the vibration apparatus 500, but aspects of the present disclosure are not limited thereto.

The third periphery portion 500e3 may be a portion between a third side (or an upper side) of the center portion 500c1 of the vibration apparatus 500 and the first long side of the vibration apparatus 500. For example, the third periphery portion 500e3 may be an upper periphery portion of the vibration apparatus 500. The fourth periphery portion 500c4 may be a portion between a fourth side (or a lower side) of the center portion 500c1 of the vibration apparatus 500 and the second long side of the vibration apparatus 500. For example, the fourth periphery portion 500c4 may be a lower periphery portion of the vibration apparatus 500.

The third periphery portion 500e3 and the fourth periphery portion 500e4 may be parallel to each other with the center portion 500c therebetween. The third periphery portion 500e3 and the fourth periphery portion 500e4 may have a same size (or area). For example, a length (or a first length) of each the third periphery portion 500e3 and the fourth periphery portion 500c4 parallel to the long side of the vibration apparatus 500 may be equal to a long-side length of the vibration apparatus 500. A width (or a second length) of each the third periphery portion 500e3 and the fourth periphery portion 500e4 parallel to the short side of the vibration apparatus 500 may have a length corresponding to ¼ to ⅓ of a short-side length of the vibration apparatus 500, but aspects of the present disclosure are not limited thereto.

The center portion 500c of the vibration apparatus 500 may include a first region 500v1 and 500h1, including the center point CP of the vibration apparatus 500, and a second region 500v2 and 500h2 and a third region 500v3 and 500h3 parallel to each other with the first region 500v1 and 500h1 therebetween. The first region 500v1 and 500h1, the second region 500v2 and 500h2, and the third region 500v3 and 500h3 may have a same size (or area), but aspects of the present disclosure are not limited thereto.

At least a portion of each of the plurality of pads 711 may be in (or at) each of the first region 500v1 and 500h1, the second region 500v2 and 500h2, and the third region 500v3 and 500h3. For example, a plurality of pads 711 may be disposed to be spaced apart from each other in (or at) each of the first region 500v1 and 500h1, the second region 500v2 and 500h2, and the third region 500v3 and 500h3. For example, the plurality of pads 711 may be disposed to be symmetric (or left-right symmetric) with respect to the center point CP of the vibration apparatus 500.

The number of pads 711 in the first region 500v1 and 500h1 may be greater than the number of pads 711 in each of the second region 500v2 and 500h2 and the third region 500v3 and 500h3, but aspects of the present disclosure are not limited thereto. For example, because pads 711 are more disposed at the first region including the center point CP of the vibration apparatus 500 in (or among) the center portion 500c of the vibration apparatus 500, a vibration of the center point CP of the center portion 500c of the vibration apparatus 500 may be further suppressed (or reduced).

The apparatus according to an aspect of the present disclosure may include six pads 711 which are disposed at the center portion 500c of the vibration apparatus 500, but aspects of the present disclosure are not limited thereto. For example, one or more of the six pads 711, as illustrated in FIG. 5, may be disposed to cover one or more of a plurality of holes 300h in (or at) a hole region 350. For example, each of the six pads 711 may be disposed to cover each of holes overlapping each other among the plurality of holes 300h.

According to an aspect of the present disclosure, four pads of the six pads 711 may be disposed to be spaced apart from one another at the first region 500v1, one pad 711 of the six pads 711 may be disposed at the second region 500v2, and one pad 711 of the six pads 711 may be disposed at the third region 500v3. For example, the four pads 711 at the first region 500v1 may be spaced apart from the center point CP of the vibration apparatus 500 and may be disposed to be symmetric (or horizontally symmetric or left-right symmetric) with respect to the center point CP of the vibration apparatus 500. The one pad 711 at the second region 500v2 may be disposed at a center region including a center point of the second region 500v2. The one pad 711 at the third region 500v3 may be disposed at a center region including a center point of the third region 500v3. For example, the one pad 711 at the second region 500v2 may be disposed to be symmetric (or horizontally symmetric or left-right symmetric) with respect to the one pad 711 at the third region 500v3 with respect to the center point CP of the vibration apparatus 500.

According to an aspect of the present disclosure, the center portion 500c of the vibration apparatus 500 may include a first vertical region 500v1 including the center point CP of the vibration apparatus 500, a second vertical region 500v2 at one side (or a first side or a first portion) of the first vertical region 500v1, and a third vertical region 500v3 at the other side (or a second side or a second portion) of the first vertical region 500v1 opposite to the one side of the first vertical region 500v1.

The second vertical region 500v2 may be disposed between the first vertical region 500v1 and the first periphery portion 500e1. The third vertical region 500v3 may be a region between the first vertical region 500v1 and the second periphery portion 500e2. For example, the first vertical region 500v1, the second vertical region 500v2, and the third vertical region 500v3 may have a same size (or area), but aspects of the present disclosure are not limited thereto.

According to an aspect of the present disclosure, the number of pads 711 in the first vertical region 500v1 may be greater than the number of pads 711 in each of the second vertical region 500v2 and the third vertical region 500v3, but aspects of the present disclosure are not limited thereto. For example, the number of pads 711 in the first vertical region 500v1 may be a same as the number of pads 711 in each of the second vertical region 500v2 and the third vertical region 500v3.

According to an aspect of the present disclosure, the center portion 500c of the vibration apparatus 500 may include a first horizontal region 500h1 including the center point CP of the vibration apparatus 500, a second horizontal region 500h2 at one side (or a first side or a first portion) of the first horizontal region 500h1, and a third horizontal region 500h3 at the other side (or a second side or a second portion) of the first horizontal region 500h1 opposite to the one side of the first horizontal region 500h1.

The second horizontal region 500h2 may be disposed between the first horizontal region 500h1 and the third periphery portion 500e3. The third horizontal region 500h3 may be a region between the first horizontal region 500h1 and the fourth periphery portion 500e4. The first horizontal region 500h1, the second horizontal region 500h2, and the third horizontal region 500h3 may have a same size (or area), but aspects of the present disclosure are not limited thereto. For example, the number of pads 711 in the first horizontal region 500h1 may be greater than the number of pads 711 in each of the second horizontal region 500h2 and the third horizontal region 500h3, but aspects of the present disclosure are not limited thereto. For example, the number of pads 711 in the first horizontal region 500h1 may be a same as the number of pads 711 in each of the second horizontal region 500h2 and the third horizontal region 500h3.

In the apparatus according to an aspect of the present disclosure, a vibration of the center portion of the vibration apparatus 500 may be suppressed (or bound) by the plurality of pads (or six pads) 711 disposed at the center portion 500c of the vibration apparatus 500, and thus, a sound characteristic and/or a sound pressure level characteristic of a low-pitched sound band (for example, a low-pitched sound band of 200 Hz to 1 kHz) generated based on a vibration (or displacement) of the vibration apparatus 500 may be enhanced.

FIG. 10 illustrates an arrangement structure of a pad member according to an aspect of the present disclosure. FIG. 10 illustrates an aspect implemented by changing the number of pad members described above with reference to FIG. 9. In the following description, therefore, repeated descriptions of the other elements except the number of pad members and elements relevant thereto are omitted. Descriptions above with reference to FIG. 9 may be included in descriptions of FIG. 10.

With reference to FIG. 10, an apparatus according to another aspect of the present disclosure may include a plurality of pads 711 which are disposed at a center portion 500c of a vibration apparatus 500. The plurality of pads 711 may be disposed to be spaced apart from one another at the other portion, except a corner portion, of the center portion 500c of the vibration apparatus 500.

The number of pads 711 at a first region 500v1 and 500h1 may be greater than the number of pads in each of a second region 500v2 and 500h2 and a third region 500v3 and 500h3. For example, the number of pads 711 at a first vertical region 500v1 may be greater than the number of pads in each of a second vertical region 500v2 and a third vertical region 500v3. For example, the number of pads 711 at a first horizontal region 500h1 may be greater than the number of pads at each of a second horizontal region 500h2 and a third horizontal region 500h3.

The apparatus according to another aspect of the present disclosure may include seventeen pads 711 which are disposed at the center portion 500c of the vibration apparatus 500, but aspects of the present disclosure are not limited thereto. For example, one or more of the seventeen pads 711, as illustrated in FIG. 5, may be disposed to cover one or more of a plurality of holes 300h in (or at) a hole region 350. For example, each of the seventeen pads 711 may be disposed to cover each of holes overlapping each other among the plurality of holes 300h.

According to another aspect of the present disclosure, nine pads of the seventeen pads 711 may be disposed to be spaced apart from one another at the first region 500v1, four pads 711 of the seventeen pads 711 may be disposed at the second region 500v2, and four pads 711 of the seventeen pads 711 may be disposed at the third region 500v3. For example, one of nine pads 711 at the first region 500v1 among the seventeen pads 711 may be disposed at the center point CP of the vibration apparatus 500, and the other eight pads 711 may be spaced apart from one another along a periphery portion of the first region 500v1 and may be disposed to be symmetric (or horizontally symmetric) with respect to the center point CP of the vibration apparatus 500. For example, the nine pads 711 at the first region 500v1 may be disposed in a lattice form of 3 rows, 3 columns.

Four pads 711 at the second region 500v2 may be disposed at the other portion, except a corner portion, of the second region 500v2. For example, one of the four pads 711 at the second region 500v2 may be disposed at a center portion of the second region 500v2, and the other three pads 711 may be disposed to be spaced apart from one another between the center portion of the second region 500v2 and the first region 500v1.

The four pads 711 at the third region 500v3 may be disposed at the other portion, except a corner portion, of the third region 500v3. For example, one of the four pads 711 at the third region 500v3 may be disposed at a center portion of the third region 500v3, and the other three pads 711 may be disposed to be spaced apart from one another between the center portion of the third region 500v3 and the first region 500v1.

The four pads 711 at the second region 500v2 may be disposed to be symmetric (or horizontally symmetric) with respect to the four pads 711 at the third region 500v3 with respect to the center point CP of the vibration apparatus 500.

In the apparatus according to another aspect of the present disclosure, a vibration of the center portion of the vibration apparatus 500 may be suppressed (or bound) by the plurality of pads (or seventeen pads) 711 disposed at the center portion 500c of the vibration apparatus 500, and thus, a sound characteristic and/or a sound pressure level characteristic of a low-pitched sound band (for example, a low-pitched sound band of 200 Hz to 1 kHz) generated based on a vibration (or displacement) of the vibration apparatus 500 may be enhanced.

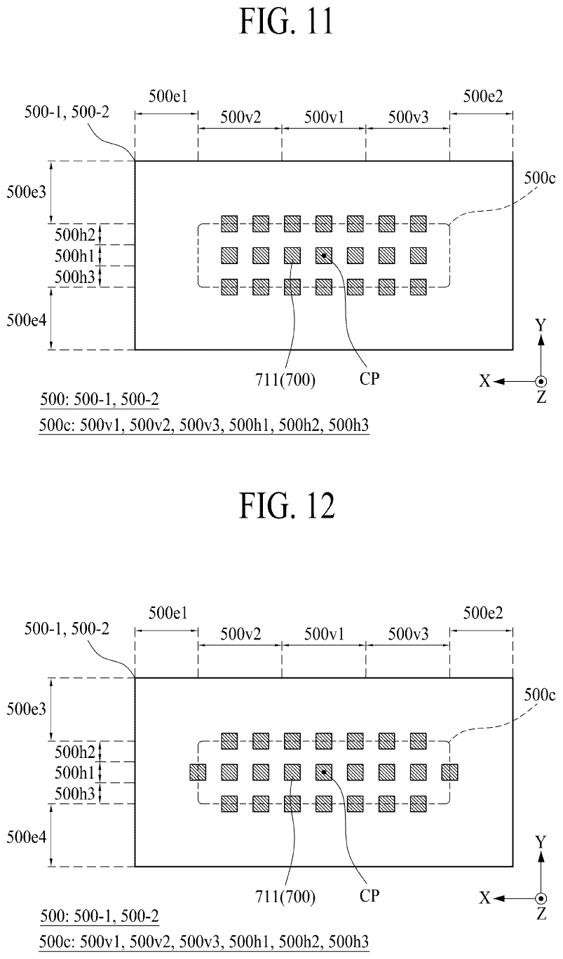

FIG. 11 illustrates an arrangement structure of a pad member according to an aspect of the present disclosure. FIG. 11 illustrates an aspect implemented by changing the number of pad members described above with reference to FIG. 10. In the following description, therefore, repeated descriptions of the other elements except the number of pad members and elements relevant thereto are omitted. Descriptions above with reference to FIGS. 9 and 10 may be included in descriptions of FIG. 11.

With reference to FIG. 11, an apparatus according to another aspect of the present disclosure may include a plurality of pads 711 which are disposed at a center portion 500c of a vibration apparatus 500. The plurality of pads 711 may be disposed in a lattice form at a center portion 500c of a vibration apparatus 500.

The number of pads 711 at a first region 500v1 may be greater than or equal to the number of pads 711 at each of a second region 500v2 and a third region 500v3. For example, the number of pads 711 at a first vertical region 500v1 may be greater than the number of pads at each of a second vertical region 500v2 and a third vertical region 500v3. For example, the number of pads 711 at a first horizontal region 500h1 may be greater than the number of pads at each of a second horizontal region 500h2 and a third horizontal region 500h3.

The apparatus according to another aspect of the present disclosure may include twenty-one (or 21) pads 711 which are disposed at the center portion 500c of the vibration apparatus 500, but aspects of the present disclosure are not limited thereto. For example, the twenty-one pads 711 may be disposed at the center portion 500c of the vibration apparatus 500 to have a lattice form of 3 rows, 7 columns. For example, one or more of the twenty-one pads 711, as illustrated in FIG. 5, may be disposed to cover one or more of a plurality of holes 300h in (or at) a hole region 350. For example, each of the twenty-one pads 711 may be disposed to cover each of holes overlapping each other among the plurality of holes 300h.

According to another aspect of the present disclosure, nine pads of the twenty-one pads 711 may be disposed to be spaced apart from one another at the first region 500v1, six pads 711 of the twenty-one pads 711 may be disposed at the second region 500v2, and six pads 711 of the twenty-one pads 711 may be disposed at the third region 500v3. For example, the nine pads 711 of the twenty-one pads 711 at the first region 500v1 and 500h1 may be disposed in a lattice form of 3 rows, 3 columns to be substantially equal to the description of FIG. 10.

The six pads 711 at the second region 500v2 may be disposed at the other portion, except one periphery portion, of the second region 500v2 adjacent to a first short side of the vibration apparatus 500. For example, the six pads 711 at the second region 500v2 may be disposed in a lattice form of 3 rows, 2 columns.

The six pads 711 at the third region 500v3 may be disposed at the other portion, except one periphery portion, of the third region 500v3 adjacent to a second short side of the vibration apparatus 500. For example, the six pads 711 at the third region 500v3 may be disposed in a lattice form of 3 rows, 2 columns.

In the apparatus according to another aspect of the present disclosure, a vibration of the center portion of the vibration apparatus 500 may be suppressed (or bound) by the plurality of pads (or twenty-one pads) 711 disposed at the center portion 500c of the vibration apparatus 500, and thus, a sound characteristic and/or a sound pressure level characteristic of a low-pitched sound band (for example, a low-pitched sound band of 200 Hz to 1 kHz) generated based on a vibration (or displacement) of the vibration apparatus 500 may be enhanced.

FIG. 12 illustrates an arrangement structure of a pad member according to an aspect of the present disclosure. FIG. 12 illustrates an aspect implemented by changing the number of pad members described above with reference to FIG. 11. In the following description, therefore, repeated descriptions of the other elements except the number of pad members and elements relevant thereto are omitted. Descriptions above with reference to FIGS. 9 to 11 may be included in descriptions of FIG. 12.

With reference to FIG. 12, an apparatus according to another aspect of the present disclosure may include a plurality of pads 711 which are disposed at a center portion 500c of a vibration apparatus 500. The plurality of pads 711 may be disposed to be spaced apart from one another at the other portion, except a corner portion, of a center portion 500c of a vibration apparatus 500.

The number of pads 711 at a first region 500v1 may be greater than or equal to the number of pads 711 at each of a second region 500v2 and a third region 500v3. For example, the number of pads 711 at a first vertical region 500v1 may be greater than the number of pads at each of a second vertical region 500v2 and a third vertical region 500v3. For example, the number of pads 711 at a first horizontal region 500h1 may be greater than the number of pads at each of a second horizontal region 500h2 and a third horizontal region 500h3.

The apparatus according to another aspect of the present disclosure may include twenty-three (or 23) pads 711 which are disposed at the center portion 500c of the vibration apparatus 500, but aspects of the present disclosure are not limited thereto. For example, one or more of the twenty-three pads 711, as illustrated in FIG. 5, may be disposed to cover one or more of a plurality of holes 300h in (or at) a hole region 350. For example, each of the twenty-three pads 711 may be disposed to cover each of holes overlapping each other among the plurality of holes 300h.

According to another aspect of the present disclosure, nine pads of the twenty-three pads 711 may be disposed to be spaced apart from one another at the first region 500v1, seven pads 711 of the twenty-three pads 711 may be disposed at the second region 500v2, and seven pads 711 of the twenty-three pads 711 may be disposed at the third region 500v3. For example, the nine pads 711 of the twenty-three pads 711 at the first region 500v1 and 500h1 may be disposed in a lattice form of 3 rows, 3 columns to be substantially equal to the description of FIG. 10.

The seven pads 711 at the second region 500v2 may be disposed at the other portion, except a corner portion, of the second region 500v2. For example, one of seven pads 711 at the second region 500v2 among the twenty-three pads 711 may be disposed at a center portion of the second region 500v2, and the other six pads 711 may be disposed at a lattice form of 3 rows, 2 columns between the center portion of the second region 500v2 and the first region 500v1.

The seven pads 711 at the third region 500v3 may be disposed at the other portion, except a corner portion, of the third region 500v3. For example, one of seven pads 711 at the third region 500v3 among the twenty-three pads 711 may be disposed at a center portion of the third region 500v3, and the other six pads 711 may be disposed at a lattice form of 3 rows, 2 columns between the center portion of the third region 500v3 and the first region 500v1.

The seven pads 711 at the second region 500v2 may be disposed to be symmetric (or horizontally symmetric or left-right symmetric) with respect to the seven pads 711 at the third region 500v3 with respect to the center point CP of the vibration apparatus 500.

In the apparatus according to another aspect of the present disclosure, a vibration of the center portion of the vibration apparatus 500 may be prevented (or bound) by the plurality of pads (or twenty-three pads) 711 disposed at the center portion 500c of the vibration apparatus 500, and thus, a sound characteristic and/or a sound pressure level characteristic of a low-pitched sound band (for example, a low-pitched sound band of 200 Hz to 1 kHz) generated based on a vibration (or displacement) of the vibration apparatus 500 may be enhanced.

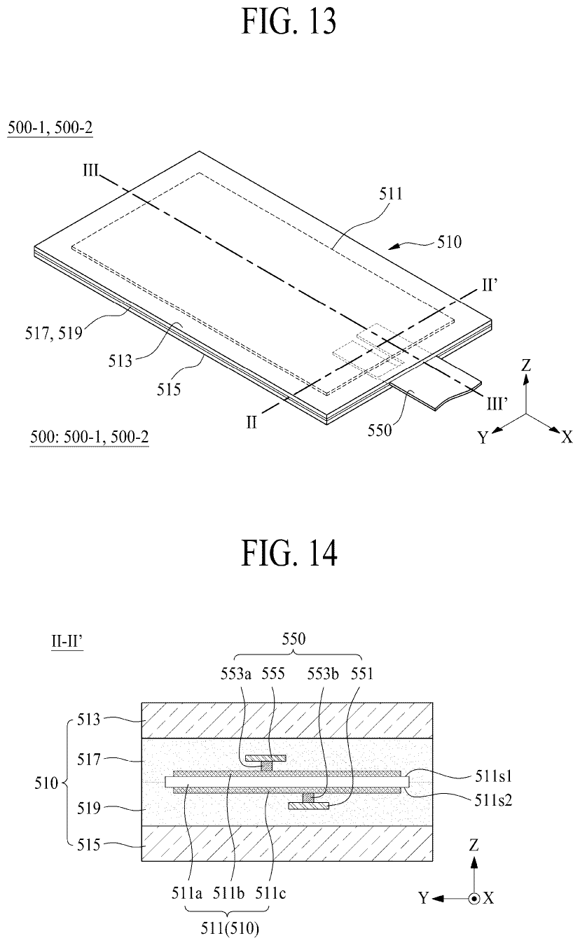

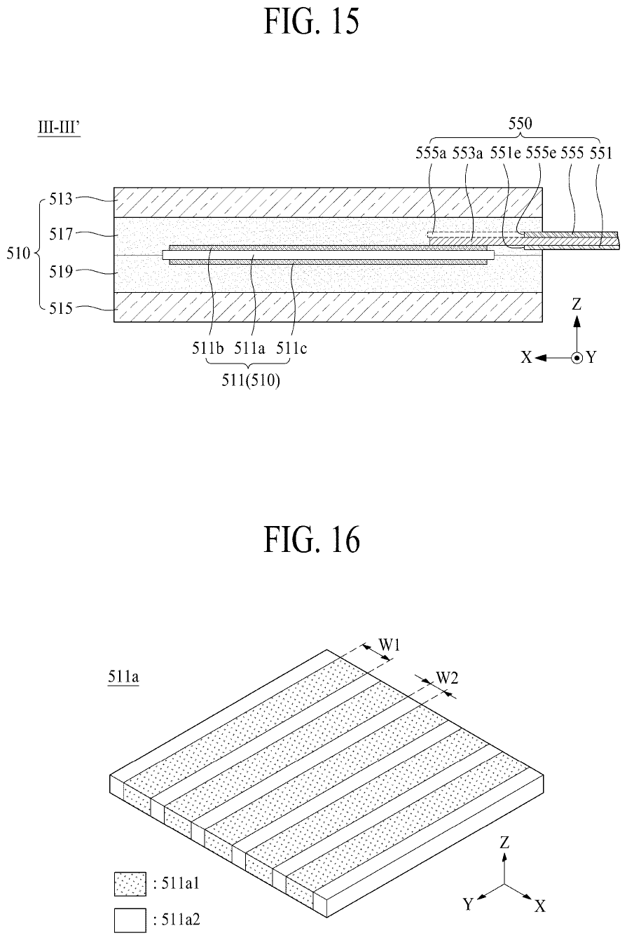

FIG. 13 illustrates a vibration apparatus according to an aspect of the present disclosure. FIG. 14 is a cross-sectional view taken along line II-II′ illustrated in FIG. 13. FIG. 15 is a cross-sectional view taken along line III-III′ illustrated in FIG. 13. FIGS. 13 to 15 illustrate a vibration apparatus described above with reference to FIGS. 1 to 12.

With reference to FIGS. 13 to 15, the vibration apparatus 500 according to an aspect of the present disclosure may include one or more vibration generator.

The vibration apparatus 500 or one or more vibration generator may include a vibration generating part 510 including a piezoelectric material. The vibration generating part 510 may be configured to vibrate based on a driving signal (or a sound signal or a voice signal). For example, the vibration generating part 510 may be a vibration device, a vibration generating device, a vibration film, a vibration generating film, a vibrator, a vibration generator, an active vibrator, an active vibration generator, an active vibration member, or the like, but aspects of the present disclosure are not limited thereto.

The vibration generating part 510 according to an aspect of the present disclosure may include a vibration part 511. The vibration part 511 may be configured to vibrate by a piezoelectric effect based on a driving signal. The vibration part 511 may include at least one or more of a piezoelectric inorganic material and a piezoelectric organic material. For example, the vibration part 511 may be a piezoelectric device, a piezoelectric device part, a piezoelectric device layer, a piezoelectric structure, a piezoelectric vibration part, a piezoelectric vibration layer, or the like, but aspects of the present disclosure are not limited thereto.

The vibration generating part 510 or the vibration part 511 according to an aspect of the present disclosure may include a vibration layer 511a, a first electrode layer 511b, and a second electrode layer 511c.

The vibration layer 511a may include a piezoelectric material or an electroactive material which includes a piezoelectric effect. For example, the piezoelectric material may have a characteristic in which, when pressure or twisting phenomenon is applied to a crystalline structure by an external force, a potential difference occurs due to dielectric polarization caused by a relative position change of a positive (+) ion and a negative (−) ion, and a vibration is generated by an electric field based on a reverse voltage applied thereto. For example, the vibration layer 511a may be a piezoelectric layer, a piezoelectric material layer, an electroactive layer, a piezoelectric composite layer, a piezoelectric composite, a piezoelectric ceramic composite, or the like, but aspects of the present disclosure are not limited thereto.

The vibration layer 511a may be configured as a ceramic-based material for implementing a relatively strong vibration, or may be configured as a piezoelectric ceramic having a perovskite-based crystalline structure. The perovskite crystalline structure may have a piezoelectric effect and/or an inverse piezoelectric effect and may be a plate-shaped structure having an orientation.

The piezoelectric ceramic may be configured as a single crystalline ceramic having a crystalline structure, or may be configured as a ceramic material having a polycrystalline structure or polycrystalline ceramic. A piezoelectric material of the single crystalline ceramic may include α-AlPO₄, α-SiO₂, LiNbO₃, Tb₂(MoO₄)₃, Li₂B₄O₇, or ZnO, but aspects of the present disclosure are not limited thereto. A piezoelectric material of the polycrystalline ceramic may include a lead zirconate titanate (PZT)-based material, including lead (Pb), zirconium (Zr), and titanium (Ti), or may include a lead zirconate nickel niobate (PZNN)-based material, including lead (Pb), zirconium (Zr), nickel (Ni), and niobium (Nb), but aspects of the present disclosure are not limited thereto. For example, the vibration layer 511a may include at least one or more of calcium titanate (CaTiO₃), barium titanate (BaTiO₃), and strontium titanate (SrTiO₃), without lead (Pb), but aspects of the present disclosure are not limited thereto.

The first electrode layer 511b may be disposed at a first surface (or an upper surface or a front surface) 511s1 of the vibration layer 511a. The first electrode layer 511b may have a same size as that of the vibration layer 511a, or may have a size which is smaller than that of the vibration layer 511a.

The second electrode layer 511c may be disposed at a second surface (or a lower surface or a rear surface) 511s2 which is opposite to or different from the first surface 511s1 of the vibration layer 511a. The second electrode layer 511c may have a same size as that of the vibration layer 511a, or may have a size which is smaller than that of the vibration layer 511a. For example, the second electrode layer 511c may have a same shape as that of the vibration layer 511a, but aspects of the present disclosure are not limited thereto.

According to an aspect of the present disclosure, to prevent electrical connection (or short circuit) between the first electrode layer 511b and the second electrode layer 511c, each of the first electrode layer 511b and the second electrode layer 511c may be formed at the other portion, except a periphery portion, of the vibration layer 511a. For example, the first electrode layer 511b may be formed at an entire first surface 511s1, other than a periphery portion, of the vibration layer 511a. For example, the second electrode layer 511c may be formed at an entire second surface 511s2, other than a periphery portion, of the vibration layer 511a. For example, a distance between a lateral surface (or a sidewall) of each of the first electrode layer 511b and the second electrode layer 511c and a lateral surface (or a sidewall) of the vibration layer 511a may be at least 0.5 mm or more. For example, the distance between the lateral surface of each of the first electrode layer 511b and the second electrode layer 511c and the lateral surface of the vibration layer 511a may be at least 1 mm or more, but aspects of the present disclosure are not limited thereto.

One or more of the first electrode layer 511b and the second electrode layer 511c according to an aspect of the present disclosure may be formed of a transparent conductive material, a semitransparent conductive material, or an opaque conductive material. For example, the transparent conductive material or the semitransparent conductive material may include indium tin oxide (ITO) or indium zinc oxide (IZO), but aspects of the present disclosure are not limited thereto. The opaque conductive material may include gold (Au), silver (Ag), platinum (Pt), palladium (Pd), molybdenum (Mo), magnesium (Mg), carbon, or silver (Ag) including glass frit, or the like, or may be made of an alloy thereof, but aspects of the present disclosure are not limited thereto. For example, to enhance an electrical characteristic and/or a vibration characteristic of the vibration layer 511a, each of the first electrode layer 511b and the second electrode layer 511c may include silver (Ag) having a low resistivity. For example, carbon may be carbon black, ketjen black, carbon nanotube, and a carbon material including graphite, but aspects of the present disclosure are not limited thereto.

In the first electrode layer 511b and the second electrode layer 511c including silver (Ag) containing the glass frit, a content of glass frit may be about 1 wt % to about 12 wt %, but aspects of the present disclosure are not limited thereto. The glass frit may include PbO or Bi₂O₃-based material, but aspects of the present disclosure are not limited thereto.

The vibration layer 511a may be polarized (or poling) by a certain voltage applied to the first electrode layer 511b and the second electrode layer 511c in a certain temperature atmosphere, or a temperature atmosphere that may be changed from a high temperature to a room temperature, but aspects of the present disclosure are not limited thereto. For example, a polarization direction (or a poling direction) formed in the vibration layer 511a may be formed or aligned (or arranged) from the first electrode layer 511b to the second electrode layer 511c, but aspects of the present disclosure are not limited thereto, and a polarization direction (or a poling direction) formed in the vibration layer 511a may be formed or aligned (or arranged) from the second electrode layer 511c to the first electrode layer 511b.

The vibration layer 511a may alternately and repeatedly contract and/or expand based on an inverse piezoelectric effect according to a driving signal applied to the first electrode layer 511b and the second electrode layer 511c from the outside to vibrate. For example, the vibration layer 511a may vibrate in a vertical direction (or thickness direction) and in a planar direction by the signal applied to the first electrode layer 511b and the second electrode layer 511c. The vibration layer 511a may be displaced (or vibrated or driven) by contraction and/or expansion of the planar direction, thereby improving a sound characteristic and/or a sound pressure level characteristic of the vibration generating part 510 or the vibration apparatus 500.

The vibration apparatus 500 or the vibration generating part 510 according to an aspect of the present disclosure may further include a first cover member 513 and a second cover member 515.

The first cover member 513 may be disposed at a first surface of the vibration part 511. For example, the first cover member 513 may be configured to cover the first electrode layer 511b of the vibration part 511. For example, the first cover member 513 may be configured to have a larger size than the vibration part 511. The first cover member 513 may be configured to protect the first surface of the vibration part 511 and the first electrode layer 511b.

The second cover member 515 may be disposed at a second surface of the vibration part 511. For example, the second cover member 515 may be configured to cover the second electrode layer 511c of the vibration part 511. For example, the second cover member 515 may be configured to have a larger size than the vibration part 511 and may be configured to have a same size as the first cover member 513. The second cover member 515 may be configured to protect the second surface of the vibration part 511 and the second electrode layer 511c.

Each of the first cover member 513 and the second cover member 515 according to an aspect of the present disclosure may include one or more materials of plastic, fiber, cloth, paper, leather, carbon, and wood, but aspects of the present disclosure are not limited thereto. For example, each of the first cover member 513 and the second cover member 515 may include a same material or different material. For example, each of the first cover member 513 and the second cover member 515 may be a polyimide film or a polyethylene terephthalate film, but aspects of the present disclosure are not limited thereto.

One or more of the first cover member 513 and the second cover member 515 according to an aspect of the present disclosure may include an adhesive member. For example, one or more of the first cover member 513 and the second cover member 515 may include an adhesive member which is coupled to or attached on the vibration part 511 and a protection member (or a stripping member) which covers or protects the adhesive member. For example, the adhesive member may include an electrical insulation material which has adhesive properties and is capable of compression and decompression. For example, the first cover member 513 may include an adhesive member which is coupled to or attached on the vibration part 511 and a protection member (or a delamination member or a stripping member) which covers or protects the adhesive member.

The first cover member 513 may be connected or coupled to the first surface of the vibration part 511 or the first electrode layer 511b by a first adhesive layer 517. For example, the first cover member 513 may be connected or coupled to the first surface of the vibration part 511 or the first electrode layer 511b by a film laminating process using the first adhesive layer 517.

The second cover member 515 may be connected or coupled to the second surface of the vibration part 511 or the second electrode layer 511c by a second adhesive layer 519. For example, the second cover member 515 may be connected or coupled to the second surface of the vibration part 511 or the second electrode layer 511c by a film laminating process using the second adhesive layer 519.

Each of the first adhesive layer 517 and second adhesive layer 519 according to an aspect of the present disclosure may include an electrically insulating material which has adhesiveness and is capable of compression and decompression. For example, each of the first adhesive layer 517 and the second adhesive layer 519 may include an epoxy resin, an acrylic resin, a silicone resin, or a urethane resin, but aspects of the present disclosure are not limited thereto.

The first adhesive layer 517 and second adhesive layer 519 may be configured between the first cover member 513 and the second cover member 515 to surround the vibration part 511. For example, one or more of the first adhesive layer 517 and second adhesive layer 519 may be configured to surround the vibration part 511.

The vibration apparatus 500 (or one or more vibration generators) according to an aspect of the present disclosure may further include a signal supply member 550.

The signal supply member 550 may be configured to supply the driving signal supplied from a vibration driving circuit to the vibration generating part 510. The signal supply member 550 may be configured to be electrically connected to the vibration part 511 at one side of the vibration generating part 510. The signal supply member 550 may be configured to be electrically connected to the first electrode layer 511b and the second electrode layer 511c of the vibration part 511. For example, the signal supply member 550 may be electrically connected to the vibration driving circuit disposed at a rear surface of the supporting member 300 through a cable hole CH (see FIG. 4, 6, or 7) configured at the supporting member 300. For example, the cable hole CH may be formed to pass through or vertically pass through the first supporting part 310 at a region between the hole region 350 of the supporting member 300 and the enclosure 600.

A portion of the signal supply member 550 may be accommodated (or inserted) between the first cover member 513 and the second cover member 515. An end portion (or a distal end portion) of the signal supply member 550 may be disposed or inserted (or accommodated) between one periphery portion of the first cover member 513 and one periphery portion of the second cover member 515. The one periphery portion of the first cover member 513 and the one periphery portion of the second cover member 515 may accommodate or vertically cover the end portion (or the distal end portion or one side) of the signal supply member 550. Accordingly, the signal supply member 550 may be integrated into the vibration generating part 510. For example, the vibration apparatus 500 according to an aspect of the present disclosure may be a vibration apparatus in which the signal supply member 550 is integrated. For example, the signal supply member 550 may be configured as a signal cable, a flexible cable, a flexible printed circuit cable, a flexible flat cable, a single-sided flexible printed circuit, a single-sided flexible printed circuit board, a flexible multilayer printed circuit, or a flexible multilayer printed circuit board, but aspects of the present disclosure are not limited thereto.

The signal supply member 550 according to an aspect of the present disclosure may include a base member 551 and a plurality of signal lines 553a and 553b. For example, the signal supply member 550 may include a base member 551, a first signal line 553a, and a second signal line 553b.

The base member 551 may include a transparent or opaque plastic material. For example, the base member 551 may be implemented as one or more of resins including a fluorine resin, a polyimide-based resin, a polyurethane-based resin, a polyester resin-based, a polyethylene-based resin, and a polypropylene-based resin, but aspects of the present disclosure are not limited thereto.

The base member 551 may have a certain width along a first direction X and may be extended long along a second direction Y intersecting with the first direction X.

The first and second signal lines 553a and 553b may be disposed at the first surface of the base member 551 in parallel with the second direction Y, and may be spaced apart from each other or electrically separated from each other in the first direction X. The first and second signal lines 553a and 553b may be disposed in parallel to each other at the first surface of the base member 551. For example, the first and second signal lines 553a and 553b may be implemented in a line shape by patterning of a metal layer (or a conductive layer) formed or deposited at the first surface of the base member 551.

End portions (or distal end portions or one sides) of the first and second signal lines 553a and 553b may be separated from each other, and thus, may be individually curved or bent.

The end portion (or a distal end portion) of the first signal line 553a may be electrically connected to the first electrode layer 511b of the vibration part 511. For example, the end portion of the first signal line 553a may be electrically connected to at least a portion of the first electrode layer 511b of the vibration part 511 at one periphery portion of the first cover member 513. For example, the end portion (or the distal end portion or one side) of the first signal line 553a may be electrically and directly connected to the first electrode layer 511b of the vibration part 511. For example, the end portion (or the distal end portion or the one side) of the first signal line 553a may be directly connected to or directly contact the first electrode layer 511b of the vibration part 511. For example, the end portion of the first signal line 553a may be electrically connected to the first electrode layer 511b by a conductive double-sided tape. Accordingly, the first signal line 553a may transfer a first driving signal, suppled from a vibration driver, to the first electrode layer 511b of the vibration part 511.

The end portion (or a distal end portion or one side) of the second signal line 553b may be electrically connected to the second electrode layer 511c of the vibration part 511. For example, the end portion of the second signal line 553b may be electrically connected to at least a portion of the second electrode layer 511c of the vibration part 511 at one periphery portion of the second cover member 515. For example, the end portion of the second signal line 553b may be electrically and directly connected to at least a portion of the second electrode layer 511c of the vibration part 511. For example, the end portion of the second signal line 553b may be directly connected to or directly contact the second electrode layer 511c of the vibration part 511. For example, the end portion of the second signal line 553b may be electrically connected to the second electrode layer 511c by a conductive double-sided tape. Accordingly, the second signal line 553b may transfer a second driving signal, suppled from the vibration driver, to the second electrode layer 511c of the vibration part 511.

The signal supply member 550 according to an aspect of the present disclosure may further include an insulation layer 555.

The insulation layer 555 may be disposed at the first surface of the base member 551 to cover each of the first signal line 553a and the second signal line 553b other than the end portion (or one side) of the signal supply member 550.

An end portion (or one side) of the signal supply member 550 including an end portion (or one side) of the base member 551 and an end portion (or one side) 555a of the insulation layer 555 may be inserted (or accommodated) between the first surface of the vibration part 511 and the first cover member 513 and may be inserted or fixed between the first surface of the vibration part 511 and the first cover member 513 by the first adhesive layer 517. For example, the end portion (or the one side) of the signal supply member 550 which is inserted (or accommodated) between the first surface of the vibration part 511 and the first cover member 513 may be inserted (or accommodated) or fixed between the first surface of the vibration part 511 and the first cover member 513 by a film laminating process using the first adhesive layer 517 and/or the second adhesive layer 519. Accordingly, the end portion (or the one side) of the first signal line 553a may be maintained with being electrically connected to the first electrode layer 511b of the vibration part 511, and the end portion (or the one side) of the second signal line 553b may be maintained with being electrically connected to the second electrode layer 511c of the vibration part 511. Further, the end portion (or the one side) of the signal supply member 550 may be inserted (or accommodated) and fixed between the vibration part 511 and the first cover member 513, and thus, a contact defect (or bad connection) between the vibration generating part 510 and the signal supply member 550 caused by the movement of the signal supply member 550 may be prevented.

In the signal supply member 550 according to an aspect of the present disclosure, each of the end portion (or the one side) of the base member 551 and an end portion (or one side) 555a of the insulation layer 555 may be removed. For example, each of the end portion of the first signal line 553a and the end portion of the second signal line 553b may be exposed at the outside without being supported or covered by each of the end portion (or the one side) of the base member 551 and the end portion (or the one side) 555a of the insulation layer 555. For example, the end portion of each of the first and second signal lines 553a and 553b may protrude (or extend) to have a certain length from an end 551e of the base member 551 or an end 555e of the insulation layer 555. Accordingly, each of the end portion (or the distal end portion or the one side) of each of the first and second signal lines 553a and 553b may be individually or independently curved (or bent).

Each of the first and second signal lines 553a and 553b may be disposed only between the base member 551 and the insulation layer 555. The end portion (or the one side) of the first signal line 553a, which is not supported by the end portion (or the one side) of the base member 551 and the end portion 555a of the insulation layer 555, may be directly connected to or directly contact the first electrode layer 511b of the vibration part 511. The end of the second signal line 553b, which is not supported by the end portion (or the one side) of the base member 551 and the end portion (or the one side) 555a of the insulation layer 555, may be directly connected to or directly contact the second electrode layer 511c of the vibration part 511.

According to an aspect of the present disclosure, a portion of the signal supply member 550 (or a portion of the base member 551) may be disposed or inserted (or accommodated) between the first cover member 513 and the second cover member 515, and thus, the signal supply member 550 may be integrated into (configured as one body with) the vibration generating part 510. Accordingly, the vibration generating part 510 and the signal supply member 550 may be configured as one part (or one component), and thus, an effect of uni-materialization may be obtained.

According to an aspect of the present disclosure, the first signal line 553a and the second signal line 553b of the signal supply member 550 may be integrated into (configured as one body with) the vibration generating part 510, and thus, a soldering process for an electrical connection between the vibration generating part 510 and the signal supply member 550 may not be needed. Accordingly, a manufacturing process and a structure of the vibration apparatus 500 may be simplified, and thus, a hazardous process may be reduced.

FIG. 16 illustrates a vibration layer according to another aspect of the present disclosure. FIG. 16 illustrates another aspect of the vibration layer according to an aspect of the present disclosure described above with reference to FIGS. 13 to 15.

With reference to FIGS. 14 and 16, the vibration layer 511a according to another aspect of the present disclosure may include a plurality of first portions 511a1 and a plurality of second portions 511a2. For example, the plurality of first portions 511a1 and the plurality of second portions 511a2 may be alternately and repeatedly disposed along a first direction X (or a second direction Y). For example, the first direction X may be a horizontal direction (or a widthwise direction) of the vibration layer 511a, and the second direction Y may be a vertical direction (or a lengthwise direction) of the vibration layer 511a intersecting with the first direction X, but aspects of the present disclosure are not limited thereto. For example, the first direction X may be the vertical direction (or the lengthwise direction) of the vibration layer 511a, and the second direction Y may be the horizontal direction (or the widthwise direction) of the vibration layer 511a.

Each of the plurality of first portions 511a1 may include an inorganic material having a piezoelectric effect (or a piezoelectric characteristic). For example, each of the plurality of first portions 511a1 may include at least one or more of a piezoelectric inorganic material and a piezoelectric organic material. For example, each of the plurality of first portions 511a1 may be an inorganic portion, an inorganic material portion, a piezoelectric portion, a piezoelectric material portion, or an electroactive portion, but aspects of the present disclosure are not limited thereto.

According to an aspect of the present disclosure, each of the plurality of first portions 511a1 may have a first width W1 parallel to the first direction X and may be extended along the second direction Y intersecting with the first direction X. Each of the plurality of first portions 511a1 may include a material which is be substantially a same as the vibration layer 511a described above with reference to FIGS. 14 and 15, and thus, repeated descriptions thereof are omitted.

Each of the plurality of second portions 511a2 may be disposed between the plurality of first portions 511a1. For example, each of the plurality of first portions 511a1 may be disposed between two adjacent second portions 511a2 of the plurality of second portions 511a2. Each of the plurality of second portions 511a2 may have a second width W2 parallel to the first direction X (or the second direction Y) and may be extended along the second direction Y (or the first direction X). The first width W1 may be a same as or different from the second width W2. For example, the first width W1 may be greater than the second width W2. For example, the first portion 511a1 and the second portion 511a2 may include a line shape or a stripe shape which has a same size or different sizes.

Each of the plurality of second portions 511a2 may be configured to fill a gap between two adjacent first portions 511a1 of the plurality of first portions 511a1. Each of the plurality of second portions 511a2 may be configured to fill a gap between two adjacent first portions 511a1 of the plurality of first portions 511a1, and thus, may be connected to or attached on lateral surfaces of the first portion 511a1 adjacent thereto. According to an aspect of the present disclosure, each of the plurality of first portions 511a1 and the plurality of second portions 511a2 may be disposed (or arranged) at a same plane (or a same layer) in parallel with each other. Therefore, the vibration layer 511a may be expanded to a desired size or length by a lateral coupling (or connection) of the first portion 511a1 and the second portion 511a2.

According to an aspect of the present disclosure, each of the plurality of second portions 511a2 may absorb an impact applied to the first portions 511a1, and thus, may enhance the durability of the first portions 511a1 and provide flexibility to the vibration layer 511a. Each of the plurality of second portions 511a2 may include an organic material having a ductile characteristic. For example, each of the plurality of second portions 511a2 may include one or more of an epoxy-based polymer, an acrylic-based polymer, and a silicone-based polymer, but aspects of the present disclosure are not limited thereto. For example, each of the plurality of second portions 511a2 may be an organic portion, an organic material portion, an adhesive portion, a stretch portion, a bending portion, a damping portion, or a ductile portion, but aspects of the present disclosure are not limited thereto.

A first surface of each of the plurality of first portions 511a1 and the plurality of second portions 511a2 may be connected to the first electrode layer 511b in common. A second surface of each of the plurality of first portions 511a1 and the plurality of second portions 511a2 may be connected to the second electrode layer 511c in common.

The plurality of first portions 511a1 and the plurality of second portion 511a2 may be disposed on (or connected to) a same plane, and thus, the vibration layer 511a according to another aspect of the present disclosure may have a single thin film-type. Accordingly, the vibration part 511 or the vibration generating part 510 including the vibration layer 511a according to another aspect of the present disclosure may vibrate in vertically (or up and down) direction by the first portion 511a1 having a vibration characteristic and may be bent in a curved shape by the second portion 511a2 having flexibility.

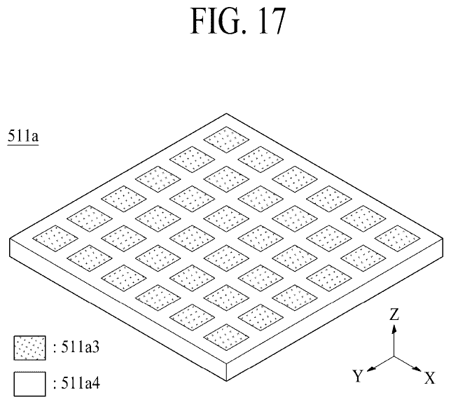

FIG. 17 illustrates a vibration layer according to another aspect of the present disclosure. FIG. 17 illustrates another aspect of the vibration layer according to an aspect of the present disclosure described above with reference to FIGS. 13 to 15.

With reference to FIGS. 14 and 17, the vibration layer 511a according to another aspect of the present disclosure may include a plurality of first portions 511a3 and a second portion 511a4 disposed between the plurality of first portions 511a3.

Each of the plurality of first portions 511a3 may be disposed to be spaced apart from one another along each of the first direction X and the second direction Y. For example, each of the plurality of first portions 511a3 may have a hexahedral shape having a same size and may be disposed in a lattice shape, but aspects of the present disclosure are not limited thereto. For example, each of the plurality of first portions 511a3 may have a circular shape plate, an oval shape plate, or a polygonal shape plate, which have a same size as each other, but aspects of the present disclosure are not limited thereto.

Each of the plurality of first portions 511a3 may include a material which is be substantially a same as the first portion 511a1 described above with reference to FIG. 16, and thus, repeated descriptions thereof are omitted.

The second portion 511a4 may be disposed between the plurality of first portions 511a3 along each of the first direction X and the second direction Y. The second portion 511a4 may be configured to fill a gap between two adjacent first portions 511a3 or to surround each of the plurality of first portions 511a3, and thus, the second portion 511a4 may be connected to or attached on the first portion 511a3 adjacent thereto. The second portion 511a4 may include a material which is be substantially a same as the second portion 511a2 described above with reference to FIG. 16, and thus, repeated descriptions thereof are omitted.

A first surface of each of the plurality of first portions 511a3 and the second portions 511a4 may be connected to the first electrode layer 511b in common. A second surface of each of the plurality of first portions 511a3 and the second portions 511a4 may be connected to the second electrode layer 511c in common.

The plurality of first portions 511a3 and the second portion 511a4 may be disposed on (or connected to) a same plane, and thus, the vibration layer 511a according to another aspect of the present disclosure may have a single thin film-type. Accordingly, the vibration part 511 or the vibration generating part 510 including the vibration layer 511a according to another aspect of the present disclosure may vibrate in vertically (or up and down) direction by the first portion 511a3 having a vibration characteristic and may be bent in a curved shape by the second portion 511a4 having flexibility.

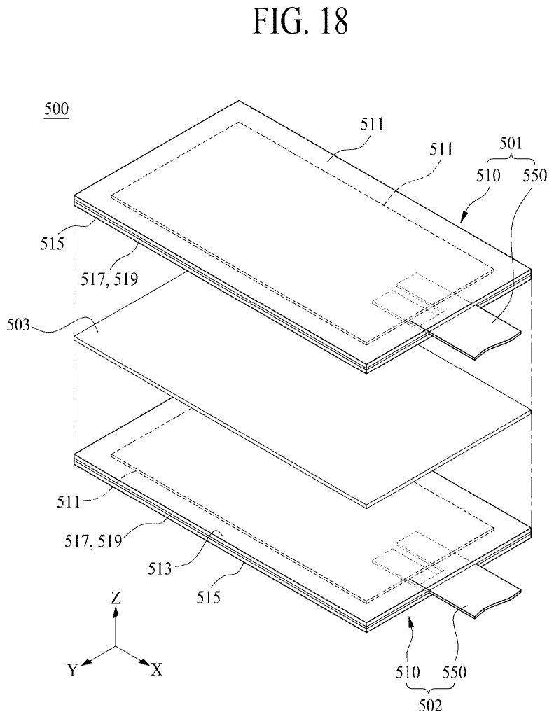

FIG. 18 is an exploded perspective view illustrating a vibration apparatus according to another aspect of the present disclosure. FIG. 18 illustrates another aspect of the vibration apparatus according to an aspect of the present disclosure described above with reference to FIGS. 1 to 12.

With reference to FIGS. 2 and 18, the vibration apparatus 500 according to another aspect of the present disclosure a plurality of vibration generators 501 and 502, and an adhesive member 503.

The plurality of vibration generators 501 and 502 may be configured to include a piezoelectric material. The plurality of vibration generators 501 and 502 may overlap or be stacked with each other to be displaced (or driven or vibrated) in a same direction to maximize an amplitude displacement of the vibration apparatus 500 or an amplitude displacement of the vibration member 100. For example, the plurality of vibration generators 501 and 502 may have substantially a same size, but aspects of the present disclosure are not limited thereto. For example, the plurality of vibration generators 501 and 502 may have substantially a same size within an error range of a manufacturing process, but aspects of the present disclosure are not limited thereto. Therefore, the plurality of vibration generators 501 and 502 may maximize an amplitude displacement of the vibration apparatus 500 and/or an amplitude displacement of the vibration member 100.

According to an aspect of the present disclosure, when at least one of the plurality of vibration generators 501 and 502 has a different size departing from an error range of a manufacturing process, the displacement directions and the amplitude displacements of the plurality of vibration generators 501 and 502 may not match with each other, and thus, the amplitude displacement of the vibration apparatus 500 may not be maximized. For example, when at least one of the plurality of vibration generators 501 and 502 is displaced in a different direction, the displacement directions of the plurality of vibration generators 501 and 502 may not match with each other, and thus, the amplitude displacement of the vibration apparatus 500 may not be maximized.

The vibration apparatus 500 according to another aspect of the present disclosure may include two or more vibration generators 501 and 502 which are stacked to be displaced in a same direction. In the following description, an example where the vibration apparatus 500 includes first and second vibration generators 501 and 502 will be described.

According to an aspect of the present disclosure, the first vibration generator 501 may be connected to or disposed at a second surface 100b of the vibration member 100 by a connection member 400. The vibration generator 502 may be disposed at or attached on the first vibration generator 501 by an adhesive member 503 (or a second connection member or an intermediate adhesive member).

Each of the plurality of vibration generators 501 and 502 may include a vibration generating part 510 and a signal supply member 550. Each of the vibration generating part 510 and the signal supply member 550 may be a same as or substantially a same as the vibration generating part 510 and the signal supply member 550 described above with reference to FIGS. 13 to 17, respectively, and are referred to by like reference numerals and repeated descriptions thereof are omitted.

A plurality of first portions which is in the first vibration generator 501 and a plurality of first portions which is in the second vibration generator 502 may have a same size. The plurality of second portions which is in the first vibration generator 501 and a plurality of second portions which is in the second vibration generator 502 may have a same size. The plurality of first portions which is in the first vibration generator 501 and the plurality of first portions which is in the second vibration generator 502 may substantially overlap or stack without being staggered. Therefore, the plurality of first portions which is in the first vibration generator 501 and the plurality of first portions which is in the second vibration generator 502 may have a same size and may be configured in a stack structure where the first portions are stacked without being staggered, and thus, the amount of displacement or an amplitude displacement of the vibration apparatus 500 may be maximized or increased.

The adhesive member 503 may be disposed between the plurality of vibration generators 501 and 502. The adhesive member 503 may be disposed between the first vibration generator 501 and the second vibration generator 502. For example, the adhesive member 503 may be disposed or connected between the second cover member 515 of the first vibration generator 501 and the first cover member 513 of the second vibration generator 502.

The adhesive member 503 according to an aspect of the present disclosure may be configured as a material including an adhesive layer which is good in attaching force or adhesive force, with respect to each of the plurality of vibration generators 501 and 502. For example, the adhesive member 503 may include a foam pad, a double-sided tape, a double-sided foam tape, a double-sided foam pad, an adhesive, or the like, but aspects of the present disclosure are not limited thereto. For example, an adhesive layer of the adhesive member 503 may include epoxy, acrylic, silicone, or urethane, but aspects of the present disclosure are not limited thereto. The adhesive layer of the adhesive member 503 may include a urethane-based material (or substance) having relatively larger ductile characteristic than that of the acrylic-based material. Accordingly, the vibration loss caused by displacement interference between the plurality of vibration generators 501 and 502 may be minimized, or each of the plurality of vibration generators 501 and 502 may be freely displaced (or vibrated or driven).

The vibration apparatus 500 according to another aspect of the present disclosure may include the plurality of vibration generators 501 and 502 which are stacked to vibrate (or displace or drive) in a same direction, and thus, the amount of displacement and/or an amplitude displacement may be maximized or increased. Accordingly, the amount of displacement (or a bending force) or an amplitude displacement of a vibration member 100 may be maximized or increased.

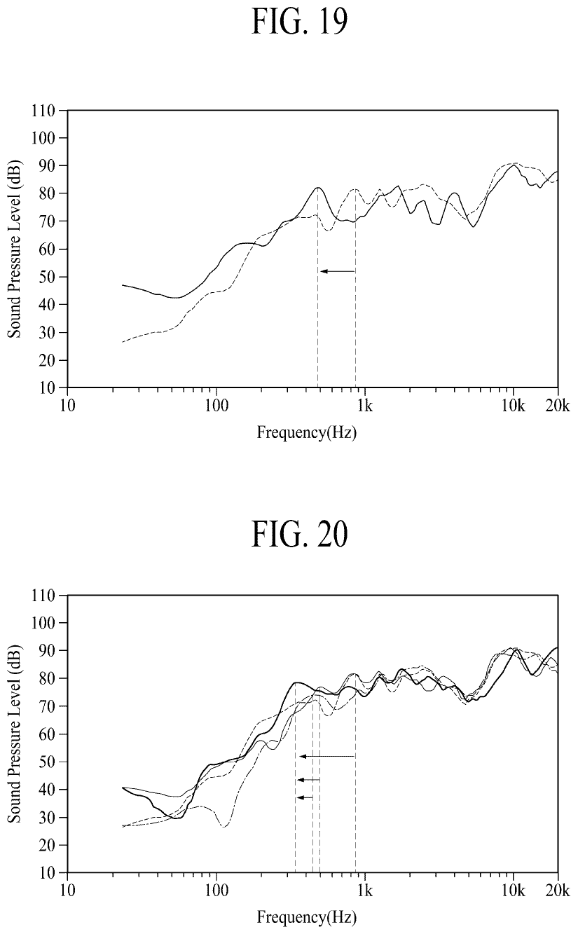

FIG. 19 is a graph showing a sound pressure level with respect to a frequency in each of an apparatus according to a first experiment example and an apparatus according to an aspect of the present disclosure. In FIG. 19, the abscissa axis represents a frequency (hertz (Hz)), and the ordinate axis represents a sound pressure level (SPL) (decibel (dB)).

In FIG. 19, a dotted line may represent a sound pressure level with respect to a frequency in the apparatus according to the first experimental example, and the apparatus according to the first experimental example may not include the plurality of pads illustrated in FIG. 4 and may include an enclosure having a tetragonal ring shape instead of an enclosure having a hexagonal ring shape. A solid line may represent a sound pressure level with respect to a frequency in the apparatus according to an aspect of the present disclosure, and the apparatus according to an aspect of the present disclosure may not include the six pads illustrated in FIG. 4 and may include an enclosure having a hexagonal ring shape.

As seen in FIG. 19, comparing with the dotted line, in the solid line, it may be seen that a resonance frequency decreases (illustrated by an arrow). Therefore, because the apparatus according to an aspect of the present disclosure includes the enclosure having a hexagonal ring shape, a resonance frequency of a vibration apparatus and/or a vibration member may decrease due to a vibration region which is approximately circular in shape, and thus, a sound characteristic and/or a sound pressure level characteristic of a low-pitched sound band (for example, a pitched sound band of 200 Hz to 1 kHz) generated based on a vibration (or displacement) of a vibration apparatus may be enhanced.

FIG. 20 is a graph showing a sound pressure level with respect to a frequency in each of apparatuses according to first to third experiment examples and an apparatus according to an aspect of the present disclosure. In FIG. 20, the abscissa axis represents a frequency (hertz (Hz)), and the ordinate axis represents a sound pressure level (SPL) (decibel (dB)).

In FIG. 20, a dotted line may represent a sound pressure level with respect to a frequency in the apparatus according to the first experimental example described above with reference to FIG. 19. A dash-single dotted line may represent a sound pressure level with respect to a frequency in the apparatus according to the second experimental example, and the apparatus according to the second experimental example may include one pad member having a size corresponding to a center portion of a vibration apparatus instead of the six pads illustrated in FIG. 4 and may include an enclosure having a tetragonal ring shape instead of an enclosure having a hexagonal ring shape. A solid line may represent a sound pressure level with respect to a frequency in the apparatus according to the third experimental example, and the apparatus according to the third experimental example may include the six pads illustrated in FIG. 4 or FIG. 9 and may include an enclosure having a tetragonal ring shape instead of an enclosure having a hexagonal ring shape. A thick solid line may represent a sound pressure level with respect to a frequency in the apparatus according to an aspect of the present disclosure, and the apparatus according to an aspect of the present disclosure may include the six pads illustrated in FIG. 4 and an enclosure having a hexagonal ring shape.

As seen in FIG. 20, comparing with each of the dotted line, the dash-single dotted line, and the solid line, in the thick solid line, it may be seen that a resonance frequency decreases (illustrated by an arrow). Therefore, because the apparatus according to an aspect of the present disclosure includes the enclosure having a hexagonal ring shape and the six pads, a resonance frequency of a vibration apparatus and/or a vibration member may decrease because a vibration is prevented in a center portion of a vibration apparatus and a vibration region which is approximately circular in shape, and thus, a sound characteristic and/or a sound pressure level characteristic of a low-pitched sound band (for example, a sound band of 200 Hz to 1 kHz) generated based on a vibration (or displacement) of a vibration apparatus may be enhanced. For example, comparing with the dotted line, in the thick solid line, an average sound pressure level in 250 Hz to 700 Hz may increase about 0.4 dB.

As seen in FIG. 20, comparing with the dotted line, in the thick solid line, it may be seen that the flatness of a sound pressure level corresponding to a deviation between a highest sound pressure level and a lowest sound pressure level is improved in, for example, 250 Hz to 1 kHz. For example, comparing with the dotted line, the thick solid line may have a high-pitched sound pressure level of about 0.4 dB in 205 Hz to 700 Hz.

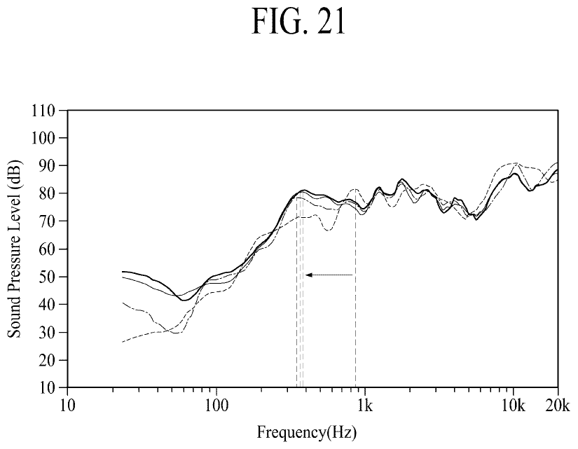

FIG. 21 is a graph showing a sound pressure level with respect to a frequency in each of the apparatus according to the second experimental example and an apparatus according to another aspect of the present disclosure. In FIG. 21, the abscissa axis represents a frequency (hertz Hz), and the ordinate axis represents a sound pressure level (SPL) (decibel dB).

In FIG. 21, a dotted line may represent a sound pressure level with respect to a frequency in the apparatus according to the first experimental example described above with reference to FIG. 19. A dash-single dotted line may represent a sound pressure level with respect to a frequency in the apparatus according to an aspect of the present disclosure including the six pads illustrated in FIG. 4 or 9 and the enclosure having a hexagonal ring shape illustrated in FIG. 4. A solid line may represent a sound pressure level with respect to a frequency in the apparatus according to another aspect of the present disclosure including the seventeen pads illustrated in FIG. 10 and the enclosure having a hexagonal ring shape illustrated in FIG. 4. A thick solid line may represent a sound pressure level with respect to a frequency in the apparatus according to another aspect of the present disclosure including the twenty-one pads illustrated in FIG. 11 and the enclosure having a hexagonal ring shape illustrated in FIG. 4.

As seen in FIG. 21, comparing with the dotted line, in each of the dash-single dotted line, the solid line, and the thick solid line, it may be seen that a resonance frequency decreases (illustrated by an arrow). Therefore, because the apparatus according to aspects of the present disclosure includes the enclosure having a hexagonal ring shape and a plurality of pads spaced apart from one another, a vibration may be prevented in a center portion of a vibration apparatus and a vibration region which is approximately circular in shape, and due to this, a resonance frequency of a vibration apparatus and/or a vibration member may decrease, and thus, a sound characteristic and/or a sound pressure level characteristic of a low-pitched sound band (for example, a pitched sound band of 200 Hz to 1 kHz) generated based on a vibration (or displacement) of a vibration apparatus may be enhanced. For example, comparing with the dotted line, in the dash-single dotted line, an average sound pressure level in 250 Hz to 700 Hz may increase about 0.4 dB. Comparing with the dotted line, in the solid line, an average sound pressure level in 250 Hz to 700 Hz may increase about 2.0 dB. Comparing with the dotted line, in the thick solid line, an average sound pressure level in 250 Hz to 700 Hz may increase about 2.7 dB.

As seen in FIG. 21, comparing with the dotted line, in each of the dash-single dotted line, the solid line, and the thick solid line, it may be seen that the flatness of a sound pressure level corresponding to a deviation between a highest sound pressure level and a lowest sound pressure level is improved in, for example, 200 Hz to 1 kHz.

An apparatus according to an aspect of the present disclosure are described below.

An apparatus according to one or more aspects of the present disclosure may comprise a vibration member; a vibration apparatus configured to vibrate the vibration member; a supporting member at a rear surface of the vibration apparatus and the vibration member, the supporting member including a hole region overlapping the vibration apparatus; an enclosure configured between the vibration member and the supporting member to surround the vibration apparatus; and a pad member between the vibration apparatus and the hole region of the supporting member. The pad member may be connected to one or more of the rear surface of the vibration apparatus and the supporting member.

According to one or more aspects of the present disclosure, the pad member may contact the rear surface of the vibration apparatus.

According to one or more aspects of the present disclosure, the apparatus may further comprise a first adhesive member between the pad member and the supporting member, and a second adhesive member between the pad member and the rear surface of the vibration apparatus.

According to one or more aspects of the present disclosure, the enclosure may comprise a polygonal ring shape or a circular ring shape surrounding the vibration apparatus and the hole region. The polygonal ring shape may comprise a plurality of internal angles. Each of the plurality of internal angles may be an obtuse angle.

According to one or more aspects of the present disclosure, the hole region may comprise a plurality of holes disposed to have a predetermined interval. The pad member may cover one or more of the plurality of holes.

According to one or more aspects of the present disclosure, the pad member may comprise a plurality of pads spaced apart from one another. One or more of the plurality of pads may cover one or more of the plurality of holes.

According to one or more aspects of the present disclosure, a center portion of the vibration apparatus may be disposed at a center portion of the hole region.

An apparatus according to one or more aspects of the present disclosure may comprise a vibration member; a supporting member at a rear surface of the vibration member, the supporting member including a hole region; an enclosure configured to provide a gap space between the vibration member and the hole region of the supporting member; a vibration apparatus at the gap space and configured to vibrate the vibration member; and a pad member at the gap space.

According to one or more aspects of the present disclosure, the pad member may be connected to the hole region of the supporting member to support a center portion of the vibration apparatus.

According to one or more aspects of the present disclosure, the pad member may be connected to one or more of the rear surface of the vibration apparatus and the supporting member by an adhesive member.

According to one or more aspects of the present disclosure, the apparatus may further comprise a first adhesive member between the pad member and the supporting member, and a second adhesive member between the pad member and the rear surface of the vibration apparatus.

According to one or more aspects of the present disclosure, the enclosure may comprise a polygonal ring shape or a circular ring shape surrounding the vibration apparatus and the hole region. The polygonal ring shape may comprise a plurality of internal angles. Each of the plurality of internal angles may be an obtuse angle.

According to one or more aspects of the present disclosure, the hole region may comprise a plurality of holes disposed to have a predetermined interval. The pad member may cover one or more of the plurality of holes.

According to one or more aspects of the present disclosure, the pad member may comprise a plurality of pads spaced apart from one another. One or more of the plurality of pads may cover one or more of the plurality of holes.

According to one or more aspects of the present disclosure, the pad member may be configured in a plastic material or a metal material.

According to one or more aspects of the present disclosure, the vibration apparatus may comprise a center portion including a center point and a periphery portion surrounding the center portion. The pad member may be disposed at the center portion of the vibration apparatus.

According to one or more aspects of the present disclosure, the pad member may comprise a plurality of pads spaced apart from one another.

According to one or more aspects of the present disclosure, the center portion of the vibration apparatus may comprise a first region including the center point, and a second region and a third region parallel to each other with the first region therebetween. The number of pads at the first region may be greater than or equal to the number of pads at each of the second region and the third region.

According to one or more aspects of the present disclosure, the center portion of the vibration apparatus may comprise a first vertical region including the center point, a second vertical region at one side of the first vertical region, and a third vertical region at the other side of the first vertical region opposite to the one side of the first vertical region. The number of pads at the first vertical region may be greater than the number of pads at each of the second vertical region and the third vertical region.

According to one or more aspects of the present disclosure, the center portion of the vibration apparatus may comprise a first horizontal region including the center point, a second horizontal region at one side of the first horizontal region, and a third horizontal region at the other side of the first horizontal region opposite to the one side of the first horizontal region. The number of pads at the first horizontal region may be greater than or equal to the number of pads at each of the second horizontal region and the third horizontal region.

According to one or more aspects of the present disclosure, the vibration member may comprise a first region and a second region. The vibration apparatus may comprise a first vibration apparatus configured to vibrate the first region of the vibration member, and a second vibration apparatus configured to vibrate the second region of the vibration member.

According to one or more aspects of the present disclosure, the hole region may comprise a first hole region having a size which is greater than a size of the first vibration apparatus, and a second hole region having a size which is greater than a size of the second vibration apparatus.

According to one or more aspects of the present disclosure, the pad member may comprise a plurality of first pad members configured to be spaced apart from one another between the first hole region and the first vibration apparatus, and a plurality of second pad members configured to be spaced apart from one another between the second hole region and the second vibration apparatus.

According to one or more aspects of the present disclosure, the enclosure may comprise a first enclosure configured between the vibration member and the supporting member to surround the first vibration apparatus and the first hole region, and a second enclosure configured between the vibration member and the supporting member to surround the second vibration apparatus and the second hole region.

According to one or more aspects of the present disclosure, the vibration apparatus may comprise a vibration generating part. The vibration generating part may comprise a first cover member; the second cover member; and a vibration part between the first cover member and the second cover member, the vibration part including a piezoelectric material.

According to one or more aspects of the present disclosure, the vibration part may include a plurality of first portions and one or more second portions between the plurality of first portions. Each of the plurality of first portions may include at least one or more of a piezoelectric inorganic material and a piezoelectric organic material. The one or more second portions may include an organic material.

According to one or more aspects of the present disclosure, the vibration generating part may further comprise a signal supply member electrically connected to the vibration part. A portion of the signal supply member may be accommodated between the first cover member and the second cover member.

According to one or more aspects of the present disclosure, the vibration apparatus may comprise a plurality of vibration generators, and an adhesive member between the plurality of vibration generators.

According to one or more aspects of the present disclosure, the vibration member may comprise a display panel including a pixel configured to display an image.

According to one or more aspects of the present disclosure, the vibration member may comprise one or more materials of metal, plastic, fiber, leather, wood, cloth, rubber, carbon, glass, and paper.

An apparatus according to one or more aspects of the present disclosure may comprise a vibration member configured to generate vibration or sound, a vibration apparatus configured to vibrate or sound the vibration member based on a displacement of the vibration member, a supporting member accommodating the vibration member and the vibration apparatus, a low-pitched sound band expander surrounding the vibration apparatus and optimizing a vibration region of the vibration member to increase a low-pitched sound band of the vibration apparatus, and a high-pitched sound band adjustor connecting the vibration apparatus and the supporting member and preventing the vibration of a center portion of the vibration apparatus to decrease a high-pitched sound band of the vibration apparatus.

According to one or more aspects of the present disclosure, the apparatus may further comprise a plurality of holes in the supporting member, and a pad member connected to one or more of the rear surface of the vibration apparatus and the supporting member.

According to one or more aspects of the present disclosure, the pad member may cover one or more of the plurality of holes.

According to one or more aspects of the present disclosure, the high-pitched sound band adjustor may include the pad member.

According to one or more aspects of the present disclosure, the low-pitched sound band expander may be between the vibration member and the supporting member and may surround the vibration apparatus and the pad member.

According to one or more aspects of the present disclosure, the high-pitched sound band adjustor may include a plastic material or a metal material.

According to one or more aspects of the present disclosure, the low-pitched sound band expander may be between the vibration member and the supporting member and may comprise a polygonal ring shape or a circular ring shape surrounding the vibration apparatus.

According to one or more aspects of the present disclosure, the polygonal ring shape may comprise a plurality of internal angles. Each of the plurality of internal angles may be an obtuse angle.

According to one or more aspects of the present disclosure, the vibration member may comprise a display panel including a pixel configured to display an image.

According to one or more aspects of the present disclosure, the vibration member may comprise one or more materials of metal, plastic, fiber, leather, wood, cloth, rubber, carbon, glass, and paper.

A vibration apparatus according to one or more aspects of the present disclosure may be applied to or included in a sound apparatus which is disposed in an apparatus. The vibration apparatus according to one or more aspects of the present disclosure may be applied to or included in mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCs, netbook computers, workstations, navigation apparatuses, automotive navigation apparatuses, automotive display apparatuses, automotive apparatuses, theater apparatuses, theater display apparatuses, TVs, wall paper display apparatuses, signage apparatuses, game machines, notebook computers, monitors, cameras, camcorders, and home appliances, or the like. Moreover, the vibration apparatus according to one or more aspects of the present disclosure may be applied to or included in an organic light-emitting lighting apparatus or an inorganic light-emitting lighting apparatus. When the vibration apparatus is applied to or included in the lighting apparatuses, the lighting apparatuses may act as lighting and a speaker. Further, when the vibration apparatus according to one or more aspects of the present disclosure is applied to or included in a sound apparatuses such as mobile apparatuses or the like, the sound apparatuses may be one or more of a speaker, a receiver, and a haptic device, but aspects of the present disclosure are not limited thereto.

It will be apparent to those skilled in the art that various modifications and variations can be made in the present disclosure without departing from the scope of the disclosures. Thus, it is intended that the present disclosure covers the modifications and variations of this disclosure that come within the scope of the claims and their equivalents.

What is claimed is:

1. An apparatus, comprising:
a vibration member;
a vibration apparatus configured to vibrate the vibration member;
a supporting member disposed at a rear surface of the vibration apparatus and the vibration member, wherein the supporting member includes a hole region overlapping the vibration apparatus;
an enclosure disposed between the vibration member and the supporting member and surrounding the vibration apparatus; and
a pad member disposed between the vibration apparatus and the hole region of the supporting member,
wherein the pad member is connected to one or more of the rear surface of the vibration apparatus and the supporting member.

2. The apparatus of claim 1, wherein the pad member contacts the rear surface of the vibration apparatus.

3. The apparatus of claim 1, further comprising:
a first adhesive member disposed between the pad member and the supporting member; and
a second adhesive disposed member between the pad member and the rear surface of the vibration apparatus.

4. The apparatus of claim 1, wherein the enclosure comprises a polygonal ring shape or a circular ring shape surrounding the vibration apparatus and the hole region,
wherein the polygonal ring shape comprises a plurality of internal angles, and
wherein each of the plurality of internal angles is an obtuse angle.

5. The apparatus of claim 1, wherein the hole region comprises a plurality of holes disposed to have a predetermined interval, and
wherein the pad member covers one or more of the plurality of holes.

6. The apparatus of claim 5, wherein the pad member comprises a plurality of pads spaced apart from one another, and
wherein one or more of the plurality of pads cover one or more of the plurality of holes.

7. The apparatus of claim 1, wherein a center portion of the vibration apparatus is disposed at a center portion of the hole region.

8. An apparatus, comprising:
a vibration member;
a supporting member disposed at a rear surface of the vibration member, wherein the supporting member has a hole region;
an enclosure providing a gap space between the vibration member and the hole region of the supporting member;
a vibration apparatus disposed at the gap space and configured to vibrate the vibration member; and
a pad member disposed at the gap space.

9. The apparatus of claim 8, wherein the pad member is connected to the hole region of the supporting member to support a center portion of the vibration apparatus.

10. The apparatus of claim 8, wherein the pad member is connected to one or more of the rear surface of the vibration apparatus and the supporting member by an adhesive member.

11. The apparatus of claim 10, further comprising:
a first adhesive member disposed between the pad member and the supporting member; and
a second adhesive member disposed between the pad member and the rear surface of the vibration apparatus.

12. The apparatus of claim 8, wherein the enclosure comprises a polygonal ring shape or a circular ring shape surrounding the vibration apparatus and the hole region,
wherein the polygonal ring shape comprises a plurality of internal angles, and
wherein each of the plurality of internal angles is an obtuse angle.

13. The apparatus of claim 8, wherein the hole region comprises a plurality of holes disposed to have a predetermined interval, and
wherein the pad member covers one or more of the plurality of holes.

14. The apparatus of claim 13, wherein the pad member comprises a plurality of pads spaced apart from one another, and
wherein one or more of the plurality of pads cover one or more of the plurality of holes.

15. The apparatus of claim 1, wherein the pad member includes a plastic material or a metal material.

16. The apparatus of claim 1, wherein the vibration apparatus comprises a center portion including a center point and a periphery portion surrounding the center portion, and
wherein the pad member is disposed at the center portion of the vibration apparatus.

17. The apparatus of claim 16, wherein the pad member comprises a plurality of pads spaced apart from one another.

18. The apparatus of claim 17, wherein the center portion of the vibration apparatus comprises a first region including the center point, and a second region and a third region parallel to each other with the first region therebetween, and
wherein the number of pads at the first region is greater than or equal to the number of pads at each of the second region and the third region.

19. The apparatus of claim 17, wherein the center portion of the vibration apparatus comprises:
a first vertical region including the center point;
a second vertical region at one side of the first vertical region; and
a third vertical region at another side of the first vertical region opposite to the one side of the first vertical region, and
wherein the number of pads at the first vertical region is greater than the number of pads at each of the second vertical region and the third vertical region.

20. The apparatus of claim 17, wherein the center portion of the vibration apparatus comprises:
a first horizontal region including the center point;
a second horizontal region at one side of the first horizontal region; and
a third horizontal region at another side of the first horizontal region opposite to the one side of the first horizontal region, and
wherein the number of pads at the first horizontal region is greater than or equal to the number of pads at each of the second horizontal region and the third horizontal region.

21. The apparatus of claim 1, wherein the vibration member comprises a first region and a second region, and
wherein the vibration apparatus comprises:
a first vibration apparatus configured to vibrate the first region of the vibration member; and
a second vibration apparatus configured to vibrate the second region of the vibration member.

22. The apparatus of claim 21, wherein the hole region comprises:
a first hole region having a size greater than a size of the first vibration apparatus; and
a second hole region having a size greater than a size of the second vibration apparatus.

23. The apparatus of claim 22, wherein the pad member comprises:
a plurality of first pad members spaced apart from one another between the first hole region and the first vibration apparatus; and
a plurality of second pad members spaced apart from one another between the second hole region and the second vibration apparatus.

24. The apparatus of claim 22, wherein the enclosure comprises:
a first enclosure disposed between the vibration member and the supporting member to surround the first vibration apparatus and the first hole region; and
a second enclosure disposed between the vibration member and the supporting member to surround the second vibration apparatus and the second hole region.

25. The apparatus of claim 1, wherein the vibration apparatus comprises a vibration generating part, and
wherein the vibration generating part comprises:
a first cover member;
a second cover member; and
a vibration part disposed between the first cover member and the second cover member, the vibration part including a piezoelectric material.

26. The apparatus of claim 25, wherein the vibration part includes a plurality of first portions and one or more second portions disposed between the plurality of first portions,
wherein each of the plurality of first portions includes at least one or more of a piezoelectric inorganic material and a piezoelectric organic material, and
wherein the one or more second portions include an organic material.

27. The apparatus of claim 25, wherein the vibration generating part further comprises a signal supply member electrically connected to the vibration part, and
wherein a portion of the signal supply member is accommodated between the first cover member and the second cover member.

28. The apparatus of claim 1, wherein the vibration apparatus comprises:
a plurality of vibration generators; and
an adhesive member between the plurality of vibration generators.

29. The apparatus of claim 1, wherein the vibration member comprises a display panel including a pixel configured to display an image.

30. The apparatus of claim 1, wherein the vibration member comprises one or more materials of metal, plastic, fiber, leather, wood, cloth, rubber, carbon, glass, and paper.

31. An apparatus, comprising:
a vibration member configured to generate vibration or sound;
a vibration apparatus configured to vibrate or sound the vibration member based on a displacement of the vibration member;
a supporting member accommodating the vibration member and the vibration apparatus;
a low-pitched sound band expander surrounding the vibration apparatus and optimizing a vibration region of the vibration member to increase a low-pitched sound band of the vibration apparatus; and
a high-pitched sound band adjustor connecting the vibration apparatus and the supporting member and preventing the vibration of a center portion of the vibration apparatus to decrease a high-pitched sound band of the vibration apparatus.

32. The apparatus of claim 31, further comprising:
a plurality of holes in the supporting member; and
a pad member connected to one or more of the rear surface of the vibration apparatus and the supporting member.

33. The apparatus of claim 32, wherein the pad member covers one or more of the plurality of holes.

34. The apparatus of claim 32, wherein the high-pitched sound band adjustor includes the pad member.

35. The apparatus of claim 32, wherein the low-pitched sound band expander is between the vibration member and the supporting member and surrounds the vibration apparatus and the pad member.

36. The apparatus of claim 31, wherein the high-pitched sound band adjustor includes a plastic material or a metal material.

37. The apparatus of claim 31, wherein the low-pitched sound band expander is between the vibration member and the supporting member and comprises a polygonal ring shape or a circular ring shape surrounding the vibration apparatus.

38. The apparatus of claim 37, wherein the polygonal ring shape comprises a plurality of internal angles, and
wherein each of the plurality of internal angles is an obtuse angle.

39. The apparatus of claim 31, wherein the vibration member comprises a display panel including a pixel configured to display an image.

40. The apparatus of claim 31, wherein the vibration member comprises one or more materials of metal, plastic, fiber, leather, wood, cloth, rubber, carbon, glass, and paper.
